(19) United States
(12) Patent Application Publication
(10) Pub. No.: US 2026/0162579 A1
(43) Pub. Date: Jun. 11, 2026

(54) DISPLAY DEVICE AND SUB-PIXEL RENDERING METHOD

(71) Applicant: Shenzhen China Star Optoelectronics Semiconductor Display Technology Co., Ltd., Shenzhen, Guangdong (CN)

(72) Inventor: Zeng HUANG, Shenzhen, Guangdong (CN)

(73) Assignee: Shenzhen China Star Optoelectronics Semiconductor Display Technology Co., Ltd., Shenzhen, Guangdong (CN)

(21) Appl. No.: 18/706,372

(22) PCT Filed: Mar. 4, 2024
(86) PCT No.: PCT/CN2024/079875

§ 371 Date: Apr. 30, 2024

(30) Foreign Application Priority Data
Feb. 26, 2024 (CN) 202410210684.1

(51) Int. Cl. G09G 3/20

(52) U.S. Cl. CPC G09G 3/2003; G09G 2300/0443; G09G 2300/0452; G09G 2320/0626

(57) ABSTRACT

The present application provides a display device and a sub-pixel rendering method, the display device including a display panel and a driving chip, the display panel including a plurality of pixel units sequentially arranged in a first direction and a second direction, each of the pixel units including a first sub-pixel, a second sub-pixel, and a third sub-pixel. The present application recalculates brightness of a specific sub-pixel in a target pixel unit by a sub-pixel rendering module in the driving chip, thereby mitigating a color edge effect and improving a display effect.

### TECHNICAL FIELD

The present application relates to display technologies, and more particularly, to a display device and a sub-pixel rendering method.

### BACKGROUND

An organic light-emitting diode (OLED) display panel has the following advantages over a liquid crystal display: being lighter and thinner, good in display effect, high in resolution, wide in color gamut, lower in power consumption, and capable of realizing flexible display, and has become a preferred display panel type in many display applications due to its rapid development in recent years.

Inkjet printing process is a common process for preparing an OLED display panel, which has advantages of high material utilization rate and low manufacturing cost compared to an evaporation process. Currently, users'requirement for the resolution of the OLED display panels is gradually improved, but there still is a problem with the OLED display panels prepared by the inkjet printing process that the resolution cannot meet the users'requirement due to an accuracy limitation of an inkjet printing apparatus.

In the related art, in order to achieve high resolution while reducing the requirements of the ink-jet printing process for the accuracy of the apparatus, researchers have proposed to change a pixel structure to be ink-jet printed from a conventional pixel structure to a 2-in-1-type pixel structure in which two adjacent sub-pixels share one ink drop and display same color. However, the 2-in-1-type pixel structure tends to result in a display panel prone to a color edge phenomenon, which affects user experience, and the problem is urgently to be solved.

### SUMMARY OF THE INVENTION

The present application provides a display device and a sub-pixel rendering method, which can effectively solve the problem that a display panel having a 2-in-1-type pixel structure in the display device is prone to a color edge phenomenon.

According to a first aspect, the present application provides a display device including:
a display panel including a plurality of pixel units arranged in sequence in a first direction and a second direction, the first direction intersecting the second direction, each of the pixel units including three sub-pixels of different colors, the three sub-pixels being a first sub-pixel, a second sub-pixel and a third sub-pixel, respectively, wherein the first sub-pixel in one of the pixel units is disposed on one side of the second sub-pixel and the third sub-pixel facing toward the second direction, the first sub-pixel in an adjacent one of the pixel units is disposed on one side of the second sub-pixel and the third sub-pixel facing opposite to the second direction, one side of each first sub-pixel facing toward the first direction is adjacent to the second sub-pixel, and one side of each first sub-pixel facing opposite to the first direction is adjacent to the third sub-pixel;
a driving chip electrically connected to the display panel, the driving chip including a first brightness module and a sub-pixel rendering module, wherein the first brightness module outputs a first brightness of a specific one of the sub-pixels in a target pixel unit and a first brightness of a specific one of the sub-pixel in each of the pixel units around the target pixel unit to the sub-pixel rendering module, the specific sub-pixel includes the second sub-pixel and the third sub-pixel; the sub-pixel rendering module recalculates brightness of the specific sub-pixel in the target pixel unit to output a second brightness of the specific sub-pixel in the target pixel unit.

According to a second aspect, the present application provides a sub-pixel rendering method for driving a plurality of pixel units of a display panel, wherein the display panel includes a plurality of pixel units arranged in sequence in a first direction and a second direction, the first direction intersects the second direction, each of the pixel units includes three sub-pixels of different colors, the three sub-pixels are a first sub-pixel, a second sub-pixel and a third sub-pixel, respectively, wherein the first sub-pixel in one of the pixel units is disposed on one side of the second sub-pixel and the third sub-pixel facing toward the second direction, the first sub-pixel in an adjacent one of the pixel units is disposed on one side of the second sub-pixel and the third sub-pixel facing opposite to the second direction, one side of each first sub-pixel facing toward the first direction is adjacent to the second sub-pixel, and one side of each first sub-pixel facing opposite to the first direction is adjacent to the third sub-pixel;
the sub-pixel rendering method includes the steps of:
obtaining position information of a target pixel unit and a first brightness of a specific sub-pixel in the target pixel unit, and a first brightness of a specific sub-pixel in each of the pixel units around the target pixel unit, the specific sub-pixel including the second sub-pixel and the third sub-pixel; and
recalculating brightness of the specific sub-pixel in the target pixel unit according to a rendering calculation matrix table to output a second brightness of the specific sub-pixel in the target pixel unit;
wherein the rendering calculation matrix table includes a plurality of calculation blocks, the second brightness of the specific sub-pixel in the target pixel unit is equal to a sum of values of the plurality of calculation blocks, and a value of each of the calculation blocks is obtained by multiplying the first brightness of the specific sub-pixel of one of the target pixel unit and the pixel units around the target pixel unit by a compensation coefficient, and a value of each of at least two of the plurality of calculation blocks is greater than 0.

### DESCRIPTION OF THE DRAWINGS

In order that the technical solution in the embodiments of the present application may be explained more clearly, reference will now be made briefly to the accompanying drawings required for the description of the embodiments. It will be apparent that the accompanying drawings in the following description are merely some of the embodiments of the present application, and other drawings may be made to those skilled in the art without involving any inventive effort.

FIG. 1 is a schematic block diagram of a driver chip and a display panel in a display device according to some embodiments of the present application.

FIG. 2 is a schematic plan view of a plurality of pixel units within a display area of the display panel according to some embodiments of the present application.

FIG. 3 is a schematic plan view of a target pixel unit and pixel units around the target pixel unit in a case where at least one pixel unit is disposed between the target pixel unit and any edge of the display area according to Embodiment 1 of the present application.

FIG. 4a is a distribution diagram showing a first brightness and a compensation coefficient of a second sub-pixel in a target calculation block, and a first brightness and a compensation coefficient of a second sub-pixel in a calculation block around the target calculation block in the case where at least one pixel unit is disposed between the target pixel unit and any edge of the display area according to Embodiment 1 of the present application.

FIG. 4b is a distribution diagram showing a first brightness and compensation coefficient of a third sub-pixel in the target calculation block, and a first brightness and a compensation coefficient of a third sub-pixel in a calculation block around the target calculation block in a case where at least one pixel unit is disposed between a target pixel unit and any edge of the display area according to Embodiment 1 of the present application.

FIG. 5 is a schematic plan view showing a target pixel unit and pixel units around the target pixel unit in a case where the target pixel unit is adjacent to an edge of the display area according to Embodiment 1 of the present application.

FIG. 6a is a distribution diagram showing a first brightness and a compensation coefficient of a second sub-pixel in the target calculation block, and a first brightness and a compensation coefficient of a second sub-pixel in the calculation block around the target calculation block in the case where the target pixel unit is adjacent to the edge of the display area according to Embodiment 1 of the present application.

FIG. 6b is a distribution diagram showing a first brightness and a compensation coefficient of a third sub-pixel in the target calculation block, and a first brightness and a compensation coefficient of a third sub-pixel in the calculation block around the target calculation block in the case where the target pixel unit is adjacent to the edge of the display area according to Embodiment 1 of the present application.

FIG. 7 is a schematic plan view of a target pixel unit and pixel units around the target pixel unit in a case where at least one pixel unit is disposed between the target pixel unit and any edge of the display area and a second sub-pixel and a third sub-pixel in the target pixel unit are disposed on one side of a first sub-pixel facing toward a second direction according to Embodiment 2 of the present application.

FIG. 8a is a distribution diagram showing a first brightness and a compensation coefficient of the second sub-pixel in a target calculation block, a first brightness and a compensation coefficient of the second sub-pixel in the calculation block around the target calculation block in the case where at least one pixel unit is disposed between the target pixel unit and any edge of the display area and the second sub-pixel and the third sub-pixel in the target pixel unit are disposed on one side of the first sub-pixel facing toward the second direction according to Embodiment 2 of the present application.

FIG. 8b is a distribution diagram showing a first brightness and a compensation coefficient of the third sub-pixel in the target calculation block, a first brightness and a compensation coefficient of the third sub-pixel in the calculation block around the target calculation block in the case where at least one pixel unit is disposed between the target pixel unit and any edge of the display area and the second sub-pixel and the third sub-pixel in the target pixel unit are disposed on one side of the first sub-pixel facing toward the second direction according to Embodiment 2 of the present application.

FIG. 8c is a distribution diagram showing a first brightness and a compensation coefficient of the first sub-pixel in the target calculation block, a first brightness and a compensation coefficient of the first sub-pixel in the calculation block around the target calculation block in the case where at least one pixel units is disposed between the target pixel unit and any edge of the display area and the second sub-pixel and the third sub-pixel in the target pixel unit are disposed on one side of the first sub-pixel facing toward the second direction according to Embodiment 2 of the present application.

FIG. 9 is a schematic plan view of the target pixel unit and the pixel units around the target pixel unit in a case where at least one pixel unit is disposed between the target pixel unit and any edge of the display area and the second sub-pixel and the third sub-pixel in the target pixel unit are disposed on one side of the first sub-pixel facing opposite to the second direction according to Embodiment 2 of the present application.

FIG. 10a is a distribution diagram showing a first brightness and a compensation coefficient of the second sub-pixel in the target calculation block, a first brightness and a compensation coefficient of the second sub-pixel in the calculation block around the target calculation block in the case where at least one pixel unit is disposed between the target pixel unit and any edge of the display area and the second sub-pixel and the third sub-pixel in the target pixel unit are disposed on one side of the first sub-pixel facing opposite to the second direction according to Embodiment 2 of the present application.

FIG. 10b is a distribution diagram showing a first brightness and a compensation coefficient of the third sub-pixel in the target calculation block, a first brightness and a compensation coefficient of the third sub-pixel in the calculation block around the target calculation block in the case where at least one pixel unit is disposed between the target pixel unit and any edge of the display area and the second sub-pixel and the third sub-pixel in the target pixel unit are disposed on one side of the first sub-pixel facing opposite to the second direction according to Embodiment 2 of the present application.

FIG. 10c is a distribution diagram showing a first brightness and a compensation coefficient of the first sub-pixel in the target calculation block, a first brightness and a compensation coefficient of the first sub-pixel in the calculation block around the target calculation block in the case where at least one pixel unit is disposed between the target pixel unit and any edge of the display area and the second sub-pixel and the third sub-pixel in the target pixel unit are disposed on one side of the first sub-pixel facing opposite to the second direction according to Embodiment 2 of the present application.

FIG. 11 is a schematic plan view of a target pixel unit and pixel units around the target pixel unit in a case where the target pixel unit is adjacent to an edge of the display area and a second sub-pixel and a third sub-pixel in the target pixel unit are disposed on one side of a first sub-pixel facing opposite to the second direction according to Embodiment 2 of the present application.

FIG. 12a is a distribution diagram showing a first brightness and a compensation coefficient of the second sub-pixel in the target calculation block, a first brightness and a compensation coefficient of the second sub-pixel in the calculation block around the target calculation block in the case where the target pixel unit is adjacent to the edge of the display area and the second sub-pixel and the third sub-pixel in the target pixel unit are disposed on one side of the first sub-pixel facing opposite to the second direction according to Embodiment 2 of the present application.

FIG. 12b is a distribution diagram showing a first brightness and a compensation coefficient of the third sub-pixel in the target calculation block, a first brightness and a compensation coefficient of the third sub-pixel in the calculation block around the target calculation block in the case where the target pixel unit is adjacent to the edge of the display area and the second sub-pixel and the third sub-pixel in the target pixel unit are disposed on one side of the first sub-pixel facing opposite to the second direction according to Embodiment 2 of the present application.

FIG. 12c is a distribution diagram showing a first brightness and a compensation coefficient of the first sub-pixel in the target calculation block, a first brightness and a compensation coefficient of the first sub-pixel in the calculation block around the target calculation block in the case where the target pixel unit is adjacent to the edge of the display area and the second sub-pixel and the third sub-pixel in the target pixel unit are disposed on one side of the first sub-pixel facing opposite to the second direction according to Embodiment 2 of the present application.

### Illustration of Reference Signs

display device M1; display panel M2; driving chip M3; first brightness module M31; sub-pixel rendering module M32; rendering calculation matrix table M321; display area AA; edge of display area AA1; first direction X; second direction Y; pixel unit 10; target pixel unit 11; second pixel unit 12; third pixel unit 13; fourth pixel unit 14; fifth pixel unit 15; sixth pixel unit 16; seventh pixel unit 17; eighth pixel unit 18; ninth pixel unit 19; first sub-pixel 101; second sub-pixel 102; third sub-pixel 103; calculation block 20; target calculation block 21; second calculation block 22; third calculation block 23; fourth calculation block 24; fifth calculation block 25; sixth calculation block 26; seventh calculation block 27; eighth calculation block 28; ninth calculation block 29.

### EMBODIMENTS OF THE INVENTION

According to a first aspect, the present application provides a display device comprising:
a display panel including a plurality of pixel units arranged in sequence in a first direction and a second direction, the first direction intersecting the second direction, each of the pixel units including three sub-pixels of different colors, the three sub-pixels being a first sub-pixel, a second sub-pixel and a third sub-pixel, respectively, wherein a first sub-pixel in one of the pixel units is disposed on one side of the second sub-pixel and the third sub-pixel toward the second direction, a first sub-pixel in an adjacent one of the pixel units is disposed on one side of the second sub-pixel and the third sub-pixel away from the second direction, one side of the first sub-pixel toward the first direction is adjacent to the second sub-pixel, and one side of the first sub-pixel away from the first direction is adjacent to the third sub-pixel;
a driving chip electrically connected to the display panel, the driving chip including a first brightness module and a sub-pixel rendering module, wherein the first brightness module outputs a first brightness of a specific sub-pixel in a target pixel unit and a first brightness of a specific sub-pixel in each of the pixel units around the target pixel unit to the sub-pixel rendering module, the specific sub-pixel includes the second sub-pixel and the third sub-pixel; the sub-pixel rendering module recalculates brightness of a specific sub-pixel in the target pixel unit to output a second brightness of a specific sub-pixel in the target pixel unit.

Optionally, the sub-pixel rendering module recalculates brightness of a specific sub-pixel in the target pixel unit according to a rendering calculation matrix table, wherein the rendering calculation matrix table includes a plurality of calculation blocks, a second brightness of a specific sub-pixel in the target pixel unit is equal to a sum of values of the plurality of calculation blocks, and a value of each of the calculation blocks is obtained by multiplying a first brightness of the specific sub-pixel of one of the target pixel unit and the pixel units around the target pixel unit by a compensation coefficient, and a value of at least two of the plurality of calculation blocks is greater than 0.

Optionally, the first sub-pixel is a green sub-pixel, the second sub-pixel is one of a red sub-pixel and a blue sub-pixel, the third sub-pixel is the other of a red sub-pixel and a blue sub-pixel.

Optionally, a first sub-pixel in each of the pixel units shares a pixel definition opening with a first sub-pixel in an adjacent one of the pixel units, a second sub-pixel in each of the pixel units shares a pixel definition opening with a second sub-pixel in an adjacent one of the pixel units, and a third sub-pixel in each of the pixel units shares a pixel definition opening with a third sub-pixel in an adjacent one of the pixel units.

Optionally, the rendering calculation matrix table includes a plurality of calculation blocks, a second brightness of a specific sub-pixel in the target pixel unit is equal to a sum of values of the plurality of calculation blocks, and a value of each of the calculation blocks is obtained by multiplying a first brightness of the specific sub-pixel of one of the target pixel unit and the pixel units around the target pixel unit by a compensation coefficient, and a value of at least two of the plurality of calculation blocks is greater than 0.

Optionally, the display panel has a display area, at least one of the pixel units is spaced between the target pixel unit and any edge of the display area, the pixel units around the target pixel unit include a second pixel unit, a third pixel unit, a fourth pixel unit, a fifth pixel unit, a sixth pixel unit, a seventh pixel unit, an eighth pixel unit, and a ninth pixel unit arranged in sequence in a clockwise direction, and the second pixel unit is disposed on one side of the target pixel unit toward the first direction; the plurality of calculation blocks include a target calculation block, and a second calculation block, a third calculation block, a fourth calculation block, a fifth calculation block, a sixth calculation block, a seventh calculation block, an eighth calculation block, and a ninth calculation block arranged in sequence in a clockwise direction around the target calculation block, the second calculation block is disposed on one side of the target calculation block toward the first direction;
wherein a first brightness of a specific sub-pixel in the target calculation block, the second calculation block, the third calculation block, the fourth calculation block, the fifth calculation block, the sixth calculation block, the seventh calculation block, the eighth calculation block, and the ninth calculation block corresponds to a first brightness of a specific sub-pixel in the target pixel unit, the second pixel unit, the third pixel unit, the fourth pixel unit, the fifth pixel unit, the sixth pixel unit, the seventh pixel unit, the eighth pixel unit, and the ninth pixel unit, respectively;
when the specific sub-pixel is a second sub-pixel, a compensation coefficient of a second sub-pixel of the target calculation block is k1, a compensation coefficient of a second sub-pixel of the sixth calculation block is k2, k1 and k2 are both greater than 0, the sum of k1 and k2 is equal to 1, and a compensation coefficient of a second sub-pixel of each of the other calculation blocks is 0;
when the specific sub-pixel is a third sub-pixel, a compensation coefficient of a third sub-pixel of the target calculation block is k1, a compensation coefficient of a third sub-pixel of the second calculation block is k2, k1 and k2 are both greater than 0, the sum of k1 and k2 is equal to 1, and a compensation coefficient of a third sub-pixel of each of the other calculation blocks is 0.

Optionally, the specific sub-pixel does not include a first sub-pixel.

Optionally, the display panel has a display area, at least one of the pixel units is spaced between the target pixel unit and any edge of the display area, the pixel units around the target pixel unit include a second pixel unit, a third pixel unit, a fourth pixel unit, a fifth pixel unit, a sixth pixel unit, a seventh pixel unit, an eighth pixel unit, and a ninth pixel unit arranged in sequence in a clockwise direction, and the second pixel unit is disposed on one side of the target pixel unit toward the first direction; the plurality of calculation blocks include a target calculation block, and a second calculation block, a third calculation block, a fourth calculation block, a fifth calculation block, a sixth calculation block, a seventh calculation block, an eighth calculation block, and a ninth calculation block arranged in sequence in a clockwise direction around the target calculation block, the second calculation block is disposed on one side of the target calculation block toward the first direction; wherein,
a first brightness of a specific sub-pixel in the target calculation block, the second calculation block, the third calculation block, the fourth calculation block, the fifth calculation block, the sixth calculation block, the seventh calculation block, the eighth calculation block, and the ninth calculation block corresponds to a first brightness of a specific sub-pixel in the target pixel unit, the second pixel unit, the third pixel unit, the fourth pixel unit, the fifth pixel unit, the sixth pixel unit, the seventh pixel unit, the eighth pixel unit, and the ninth pixel unit, respectively;
when a second sub-pixel and a third sub-pixel in the target pixel unit are disposed on one side of the first sub-pixel toward the second direction, and
when the specific sub-pixel is a second sub-pixel, a compensation coefficient of a second sub-pixel of the target calculation block is m1, a compensation coefficient of a second sub-pixel of the seventh calculation block is m2, a compensation coefficient of a second sub-pixel of the sixth calculation block is m3, a compensation coefficient of a second sub-pixel of the fifth calculation block is m4, a compensation coefficient of a second sub-pixel of the fourth calculation block is m5, m1, m2, m3, m4 and m5 are all greater than 0, the sum of m1, m2, m3, m4 and m5 is equal to 1, and a compensation coefficient of a second sub-pixel of each of the other calculation blocks is 0;
when the specific sub-pixel is a third sub-pixel, a compensation coefficient of a third sub-pixel of the target calculation block is m1, a compensation coefficient of a third sub-pixel of the ninth calculation block is m2, a compensation coefficient of a third sub-pixel of the second calculation block is m3, a compensation coefficient of a third sub-pixel of the fourth calculation block is m4, a compensation coefficient of a third sub-pixel of the third calculation block is m5, m1, m2, m3, m4 and m5 are all greater than 0, the sum of m1, m2, m3, m4 and m5 is equal to 1, and a compensation coefficient of a third sub-pixel of each of the other calculation blocks is 0.

Optionally, when a second sub-pixel and a third sub-pixel in the target pixel unit are disposed on one side of the first sub-pixel toward the second direction, the specific sub-pixel includes a first sub-pixel, and
when the specific sub-pixel is a first sub-pixel, a compensation coefficient of a first sub-pixel of the target calculation block is n1, a compensation coefficient of a first sub-pixel of the eighth calculation block is n2, a compensation coefficient of a first sub-pixel of the fourth calculation block is n3, n1, n2 and n3 are all greater than 0, the sum of n1, n2 and n3 is equal to 1, and a compensation coefficient of a third sub-pixel of each of the other calculation blocks is 0.

Optionally, when the second sub-pixel and the third sub-pixel in the target pixel unit are disposed on one side of the first sub-pixel away from the second direction, and
when the specific sub-pixel is a second sub-pixel, a compensation coefficient of a second sub-pixel of the target calculation block is m1, a compensation coefficient of a second sub-pixel of the fifth calculation block is m2, a compensation coefficient of a second sub-pixel of the sixth calculation block is m3, a compensation coefficient of a second sub-pixel of the seventh calculation block is m4, a compensation coefficient of a second sub-pixel of the eighth calculation block is m5, m1, m2, m3, m4 and m5 are all greater than 0, the sum of m1, m2, m3, m4 and m5 is equal to 1, and a compensation coefficient of a second sub-pixel of each of the other calculation blocks is 0;
when the specific sub-pixel is a third sub-pixel, a compensation coefficient of a third sub-pixel of the target calculation block is m1, a compensation coefficient of a third sub-pixel of the third calculation block is m2, a compensation coefficient of a third sub-pixel of the second calculation block is m3, a compensation coefficient of a third sub-pixel of the eighth calculation block is m4, a compensation coefficient of a third sub-pixel of the ninth calculation block is m5, m1, m2, m3, m4 and m5 are all greater than 0, the sum of m1, m2, m3, m4 and m5 is equal to 1, and a compensation coefficient of a third sub-pixel of each of the other calculation blocks is 0.

Optionally, when a second sub-pixel and a third sub-pixel in the target pixel unit are disposed on one side of the first sub-pixel away from the second direction, the specific sub-pixel includes a first sub-pixel, and
when the specific sub-pixel is a first sub-pixel, a compensation coefficient of a first sub-pixel of the target calculation block is n1, a compensation coefficient of a first sub-pixel of the fourth calculation block is n2, a compensation coefficient of a first sub-pixel of the eighth calculation block is n3, n1, n2, and n3 are all greater than 0, the sum of n1, n2, and n3 is equal to 1, and a compensation coefficient of a third sub-pixel of each of the other calculation blocks is 0.

Optionally, the display panel has a display area, and the target pixel unit is adjacent to an edge of the display area, wherein a first brightness of a specific sub-pixel in at least two calculation blocks of the plurality of calculation blocks corresponds to a first brightness of a specific sub-pixel in the same one of the pixel units.

According to a second aspect, the present application provides a sub-pixel rendering method for driving a plurality of pixel units of a display panel, wherein the display panel includes a plurality of pixel units arranged in sequence in a first direction and a second direction, the first direction intersects the second direction, each of the pixel units includes three sub-pixels of different colors, the three sub-pixels are a first sub-pixel, a second sub-pixel and a third sub-pixel, respectively, wherein a first sub-pixel in one of the pixel units is disposed on one side of the second sub-pixel and the third sub-pixel toward the second direction, a first sub-pixel in an adjacent one of the pixel units is disposed on one side of the second sub-pixel and the third sub-pixel away from the second direction, one side of the first sub-pixel toward the first direction is adjacent to the second sub-pixel, and one side of the first sub-pixel away from the first direction is adjacent to the third sub-pixel;
the sub-pixel rendering method includes the steps of:
obtaining position information of a target pixel unit and a first brightness of a specific sub-pixel in the target pixel unit, and a first brightness of a specific sub-pixel in each of the pixel units around the target pixel unit, the specific sub-pixel including a second sub-pixel and a third sub-pixel;
recalculating brightness of a specific sub-pixel in a target pixel unit according to a rendering calculation matrix table to output a second brightness of a specific sub-pixel in the target pixel unit;
wherein the rendering calculation matrix table includes a plurality of calculation blocks, a second brightness of a specific sub-pixel in the target pixel unit is equal to a sum of values of the plurality of calculation blocks, and a value of each of the calculation blocks is obtained by multiplying a first brightness of the specific sub-pixel of one of the target pixel unit and the pixel units around the target pixel unit by a compensation coefficient, and a value of at least two of the plurality of calculation blocks is greater than 0.

The present application provides a display device and a sub-pixel rendering method, the display device including a plurality of pixel units arranged in sequence in a first direction and a second direction, the first direction intersecting the second direction, each of the pixel units including three sub-pixels of different colors, the three sub-pixels being a first sub-pixel, a second sub-pixel and a third sub-pixel, respectively, wherein a first sub-pixel in one of the pixel units is disposed on one side of the second sub-pixel and the third sub-pixel toward the second direction, a first sub-pixel in an adjacent one of the pixel units is disposed on one side of the second sub-pixel and the third sub-pixel away from the second direction, one side of the first sub-pixel toward the first direction is adjacent to the second sub-pixel, and one side of the first sub-pixel away from the first direction is adjacent to the third sub-pixel; the driving chip including a first brightness module and a sub-pixel rendering module, wherein the first brightness module outputs a first brightness of a specific sub-pixel in a target pixel unit and a first brightness of a specific sub-pixel in each of the pixel units around the target pixel unit to the sub-pixel rendering module, the specific sub-pixel includes the second sub-pixel and the third sub-pixel; the sub-pixel rendering module recalculates brightness of a specific sub-pixel in the target pixel unit to output a second brightness of a specific sub-pixel in the target pixel unit, thereby improving the color edge effect and improving the display effect of the display panel.

In the following, the technical solutions in the embodiments of the present application will be clearly and completely described in connection with the accompanying drawings in the embodiments of the present application. It will be apparent that the described embodiments are merely a part of the embodiments of the present application, rather than all the embodiments. Based on the embodiments in the present application, all other embodiments obtained by a person skilled in the art without involving any inventive effort are within the scope of the present application. Furthermore, it is to be understood that the specific embodiments described herein are for purposes of illustration and explanation only and are not intended to limit the application. In the present application, where the contrary is not stated, the words “up” and “down” used generally refer to the up and down of the device in actual use or working condition, specifically the drawing direction in the attached drawings; the words “inside” and “outside” refer to the outline of the device.

The following disclosure provides many different embodiments or examples for implementing the different structures of the present application. In order to simplify the disclosure of the present application, components and arrangements of specific examples are described below. Of course, they are merely examples and are not intended to limit the application. In addition, the present application may repeat reference numerals and/or reference letters in various instances, such repetition being for the purpose of simplicity and clarity, without itself indicating a relationship between the various embodiments and/or arrangements discussed. In addition, the present application provides examples of various specific processes and materials, but one of ordinary skill in the art will recognize the application of other processes and/or the use of other materials. In the following detailed description, it is to be noted that the order in which the following embodiments are described is not intended to limit the preferred order of the embodiments.

### Embodiment 1

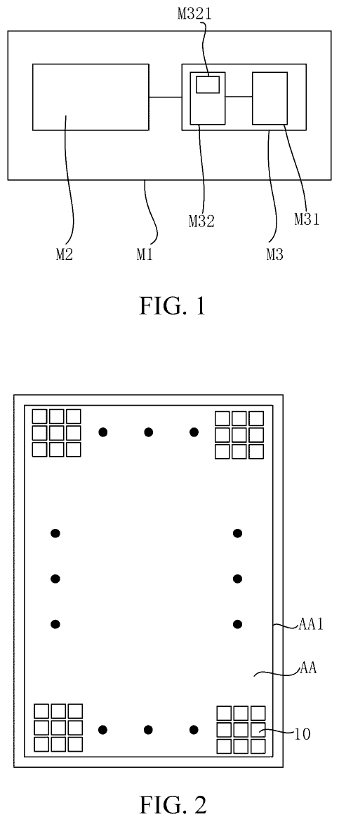

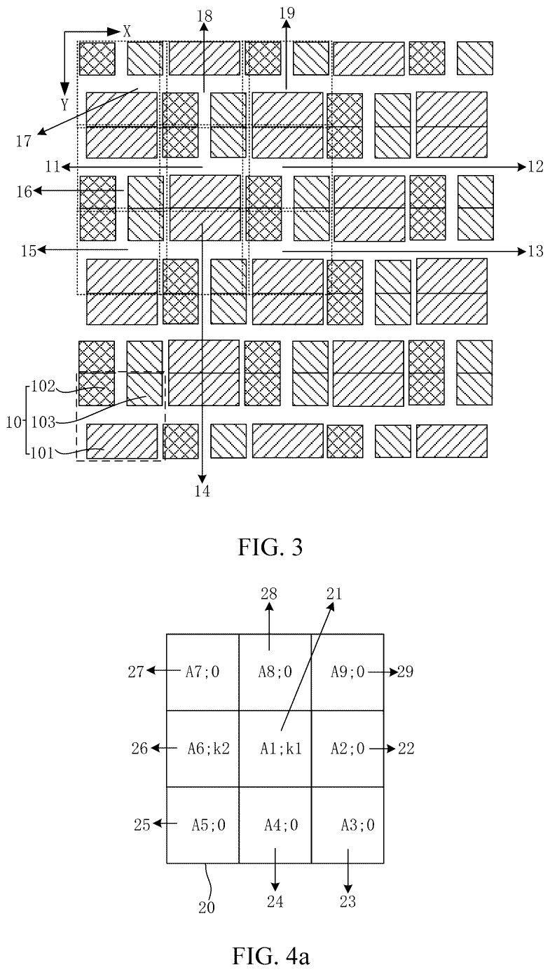

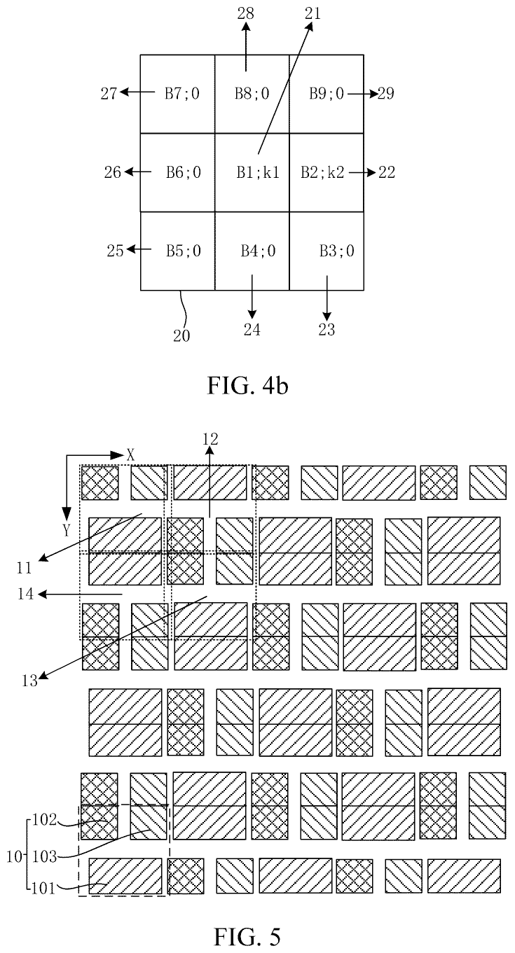

As shown in FIGS. 1 to 4 b, in a first aspect, Embodiment 1 of the present application provides the display device M1 including the display panel M2 and the driving chip M3, where the display panel M2 includes the plurality of pixel units 10 arranged in sequence in the first direction X and the second direction Y, and the first direction X intersects the second direction Y. Each of the pixel units 10 includes three sub-pixels, i.e. the first sub-pixel 101, the second sub-pixel 102, and the third sub-pixel 103, respectively. The first sub-pixel 101 in one of the pixel units 10 is disposed on one side of the second sub-pixel 102 and the third sub-pixel 103 facing toward the second direction Y, and the first sub-pixel 101 in an adjacent one of the pixel units 10 is disposed on one side of the second sub-pixel 102 and the third sub-pixel 103 facing opposite to the second direction Y, and one side of each first sub-pixel 101 facing toward the first direction X is adjacent to the second sub-pixel 102, and one side of each first sub-pixel 101 facing opposite to the first direction X is adjacent to one third sub-pixel 103. The driving chip M3 is electrically connected to the display panel M2, and includes the first brightness module M31 and the sub-pixel rendering module M32, where the first brightness module M31 outputs the first brightness of a specific sub-pixel in the target pixel unit 11 and the first brightness of a specific sub-pixel in each of the pixel units 10 around the target pixel unit 11 to the sub-pixel rendering module M32, and the specific sub-pixels include the second sub-pixel 102 and the third sub-pixel 103; and the sub-pixel rendering module M32 recalculates the brightness of the specific sub-pixel in the target pixel unit 11 to output the second brightness of the specific sub-pixel in the target pixel unit 11.

In the display panel provided in the present application, the sub-pixel rendering module M32 can recalculate the brightness of the second sub-pixel 102 and the third sub-pixel 103 in the target pixel unit 11 to output the second brightness of the second sub-pixel 102 and the third sub-pixel 103 in the target pixel unit 11, thereby mitigating the color edge effect and improving the display effect of the display panel.

Specifically, the first sub-pixel 101 in one pixel unit 10 is disposed on the side of the second sub-pixel 102 and the third sub-pixel 103 facing toward the second direction Y, the first sub-pixel 101 in the adjacent one pixel unit 10 is disposed on the side of the second sub-pixel 102 and the third sub-pixel 103 facing opposite to the second direction Y, and the side of the first sub-pixel 101 facing toward the first direction X is adjacent to the second sub-pixel 102, and the side of the first sub-pixel 101 facing opposite to the first direction X is adjacent to the third sub-pixel 103, that is, in the display panel M2 provided in the present application, the first sub-pixel 101 in each of the pixel units 10 is not disposed between the second sub-pixel 102 and the third sub-pixel 103. But this makes the display panel M2 susceptible to the color edge effect when displaying since the human-eye color mixing effect is based on the color mixing effect in which the first sub-pixel 101 is used as the center point. As the result, the display quality of the display panel M2 is deteriorated.

In the display panel M2 provided in the present application, the specific sub-pixel includes the second sub-pixel 102 and the third sub-pixel 103, that is, the present application can perform rendering on the brightness of the second sub-pixel 102 and the third sub-pixel 103 in the target pixel unit 11 by the sub-pixel rendering module M32, so that after rendering, the second sub-pixels 102 in the pixel units 10 around the target pixel unit 11 and the third sub-pixels 103 in the pixel units 10 around the target pixel unit 11 can be color mixed with the first sub-pixel 101 in the target pixel unit 11, thereby satisfying the human-eye color mixing effect as much as possible.

In some embodiments of the present application, the sub-pixel rendering module M32 recalculates the brightness of the specific sub-pixel in the target pixel unit 11 according to the rendering calculation matrix table M321 to output the second brightness of the specific sub-pixel in the target pixel unit 11, where the rendering calculation matrix table M321 includes a plurality of calculation blocks 20, the second brightness of the specific sub-pixel in the target pixel unit 11 is equal to the sum of the values of the plurality of calculation blocks 20, and the value of each of the calculation blocks 20 is obtained by multiplying the first brightness of the specific sub-pixel of one of the target pixel unit 11 and the pixel units 10 around the target pixel unit 11 by a compensation coefficient, and the values of at least two of the plurality of calculation blocks 20 are greater than 0.

In the display panel M2 provided in the present application, the sub-pixel rendering module M32 can perform the rendering process on the target pixel unit 11 based on the first brightness of the specific sub-pixel in the target pixel unit 11 and the first brightness of each sub-pixel in each of the pixel units 10 around the target pixel unit 11 output by the first brightness module M31, so that the specific sub-pixel in the target pixel unit 11 has the second brightness, thereby mitigating the color edge effect of the display panel M2 and improving the display effect of the display panel M2.

Specifically, since the second brightness of the specific sub-pixel in the target pixel unit 11 is equal to the sum of the values of the plurality of calculation blocks 20, and the value of each of the calculation blocks 20 is obtained by multiplying the first brightness of the specific sub-pixel in one of the target pixel unit 11 and the pixel units 10 around the target pixel unit 11 by the compensation coefficient, and the values of the at least two calculation blocks 20 in the plurality of calculation blocks 20 are greater than 0, the second brightness of the specific sub-pixel in the target pixel unit 11 can be influenced by the first brightness of the specific sub-pixels in at least two pixel units 10, thereby decreasing the color mixing unevenness caused by the arrangement of the sub-pixels in the target pixel unit 11, mitigating the color edge effect of the display panel M2, and improving the display quality of the display panel M2 when it displays the color corresponding to the second sub-pixels 102.

In some embodiments of the present application, the first sub-pixels 101 are the green sub-pixels, the second sub-pixels 102 are one of the red sub-pixels and the blue sub-pixels, and the third sub-pixels 103 are the other of the red sub-pixels and the blue sub-pixels.

In the display panel M2 provided in the present application, the green color contributes most to the brightness of the pixel units 10, and the human eye color mixing effect is a color mixing performed with the green sub-pixels as the center points. The present application sets the first sub-pixels 101 as the green sub-pixels, sets the second sub-pixels 102 as one of the red sub-pixels and the blue sub-pixels, and sets the third sub-pixel 103 as the other of the red sub-pixels and the blue sub-pixels, so that the sub-pixel rendering module M32 can effectively render the brightness of the red sub-pixels and the blue sub-pixels, thereby mitigating the color edge effect, and improving the display effect of the display panel M2.

In some embodiments of the present application, the first sub-pixel 101 in each of the pixel units 10 shares one pixel definition opening with the first sub-pixel 101 in an adjacent one of the pixel units 10, the second sub-pixel 102 in each of the pixel units 10 shares one pixel definition opening with the second sub-pixel 102 in an adjacent one of the pixel units 10, and the third sub-pixel 103 in each of the pixel units 10 shares one pixel definition opening with the third sub-pixel 103 in an adjacent one of the pixel units 10.

In the display panel M2 provided in the present application, since the first sub-pixel 101 in each of the pixel units 10 shares the one pixel definition opening with the first sub-pixel 101 in the adjacent one of the pixel units 10, the second sub-pixel 102 in each of the pixel units 10 shares the one pixel definition opening with the second sub-pixel 102 in the adjacent one of the pixel units 10, and the third sub-pixel 103 in each of the pixel units 10 shares the one pixel definition opening with the third sub-pixel 103 in the adjacent one of the pixel units 10, two adjacent same-color sub-pixels may be allowed to share one ink-jet print pit during the ink-jet printing of the display panel M2 without increasing the accuracy of the ink-jet printing apparatus or the number of pixel definition openings, thereby improving the resolution of the display panel M2.

In some embodiments of the present application, the display panel M2 has the display area AA. At least one of the pixel units 10 is disposed between the target pixel unit 11 and any edge AA1 of the display area AA. The pixel units 10 around the target pixel unit 11 includes the second pixel unit 12, the third pixel unit 13, the fourth pixel unit 14, the fifth pixel unit 15, the sixth pixel unit 16, the seventh pixel unit 17, an eighth pixel unit 18, and the ninth pixel unit 19 arranged in sequence in the clockwise direction, and the second pixel unit 12 is disposed on one side of the target pixel unit 11 facing toward the first direction X. The plurality of calculation blocks 20 includes the target calculation block 21, and the second calculation block 22, the third calculation block 23, the fourth calculation block 24, the fifth calculation block 25, the sixth calculation block 26, the seventh calculation block 27, the eighth calculation block 28, and the ninth calculation block 29 arranged in sequence in the clockwise direction around the target calculation block 21, and the second calculation block 22 is arranged on the side of the target calculation block 21 facing toward the first direction X. In this case, the first brightness of the specific sub-pixels in the target calculation block 21, the second calculation block 22, the third calculation block 23, the fourth calculation block 24, the fifth calculation block 25, the sixth calculation block 26, the seventh calculation block 27, the eighth calculation block 28, and the ninth calculation block 29 correspond to the first brightness of the specific sub-pixels in the target pixel unit 11, the second pixel unit 12, the third pixel unit 13, the fourth pixel unit 14, the fifth pixel unit 15, the sixth pixel unit 16, the seventh pixel unit 17, the eighth pixel unit 18, and the ninth pixel unit 19, respectively. When the specific sub-pixels are the second sub-pixels 102, the compensation coefficient of the second sub-pixel 102 of the target calculation block 21 is k1, the compensation coefficient of the second sub-pixel 102 of the sixth calculation block 26 is k2. k1 and k2 are both greater than 0, the sum of k1 and k2 is equal to 1, and the compensation coefficients of the second sub-pixels 102 of the other calculation blocks 20 are all 0. When the specific sub-pixels are the third sub-pixels 103, the compensation coefficient of the third sub-pixel 103 of the target calculation block 21 is k1, the compensation coefficient of the third sub-pixel 103 of the second calculation block 22 is k2. k1 and k2 are both greater than 0, the sum of k1 and k2 is equal to 1, and the compensation coefficients of the third sub-pixels 103 of the other calculation blocks 20 are all 0.

In the display panel M2 provided in the present application, when the specific sub-pixels are the second sub-pixels 102, the compensation coefficients of the second sub-pixels 102 of the other calculation blocks 20 are all 0 except the target calculation block 21 and the sixth calculation block 26, that is, when a rendering compensation is performed for the second sub-pixel 102 of the target pixel unit 11, only the first brightness of the second sub-pixel 102 of the target pixel unit 11 corresponding to the target calculation block 21 and the first brightness of the second sub-pixel 102 of the sixth pixel unit 16 corresponding to the sixth calculation block 26 affect the second brightness of the second sub-pixel 102 of the target calculation block 21. Similarly, when the specific sub-pixels are the third sub-pixels 103, the compensation coefficients of the third sub-pixels 103 of the other calculation blocks 20 are all 0 except the target calculation block 21 and the second calculation block 22, that is, when a rendering compensation is performed on the third sub-pixel 103 of the target pixel unit 11, only the first brightness of the third sub-pixel 103 in the target pixel unit 11 corresponding to the target calculation block 21 and the first brightness of the third sub-pixel 103 in the second pixel unit 12 corresponding to the second calculation block 22 affect the second brightness of the third sub-pixel 103 in the target calculation block 21. In summary, when the rendering compensation is performed on the second sub-pixel 102 and the third sub-pixel 103 in the target pixel unit 11, the second sub-pixel 102 in the target pixel unit 11 can be shared by the target pixel unit 11 and the sixth pixel unit 16, and the third sub-pixel 103 in the target pixel unit 11 can be shared by the target pixel unit 11 and the second pixel unit 12, so that the display of the target pixel unit 11 is more suitable for the human eye color mixing effect, thereby improving the display effect of the display panel M2, and the rendering calculation rule is simpler.

In some embodiments of the present application, k1 is 3/4 and k2 is 1/4.

In some embodiments of the present application, the first brightness of the second sub-pixel 102 in the target pixel unit 11 is A1; the first brightness of the second sub-pixel 102 in the second pixel unit 12 is A2; the first brightness of the second sub-pixel 102 in the third pixel unit 13 is A3; the first brightness of the second sub-pixel 102 in the fourth pixel unit 14 is A4; the first brightness of the second sub-pixel 102 in the fifth pixel unit 15 is A5; the first brightness of the second sub-pixel 102 in the sixth pixel unit 16 is A6; the first brightness of the second sub-pixel 102 in the seventh pixel unit 17 is A7; the first brightness of the second sub-pixel 102 in the eighth pixel unit 18 is A8; and the first brightness of the second sub-pixel 102 in the ninth pixel unit 19 is A9. Then, the second brightness of the second sub-pixel 102 in the target pixel unit 11 is the sum of the product of A1 and k1 and the product of A6 and k2.

In some embodiments of the present application, the first brightness of the third sub-pixel 103 in the target pixel unit 11 is B1; the first brightness of the third sub-pixel 103 in the second pixel unit 12 is B2; the first brightness of the third sub-pixel 103 in the third pixel unit 13 is B3; the first brightness of the third sub-pixel 103 in the fourth pixel unit 14 is B4; the first brightness of the third sub-pixel 103 in the fifth pixel unit 15 is B5; the first brightness of the third sub-pixel 103 in the sixth pixel unit 16 is B6; the first brightness of the third sub-pixel 103 in the seventh pixel unit 17 is B7; the first brightness of the third sub-pixel 103 in the eighth pixel unit 18 is B8; and the first brightness of the third sub-pixel 103 in the ninth pixel unit 19 is B9. Then, the second brightness of the third sub-pixel 103 in the target pixel unit 11 is the sum of the product of B1 and k1 and the product of B2 and k2.

In some embodiments of the present application, the specific sub-pixels do not include the first sub-pixels 101.

In the display panel M2 provided in the present application, the specific sub-pixels do not include the first sub-pixels 101, that is, the sub-pixel rendering module M32 does not recalculate and adjust the brightness of the first sub-pixel 101 in the target pixel unit 11, or it can be considered that the second brightness of the first sub-pixel 101 in the target pixel unit 11 is the first brightness of the first sub-pixel 101 in the target pixel unit 11 output by the first brightness module M31.

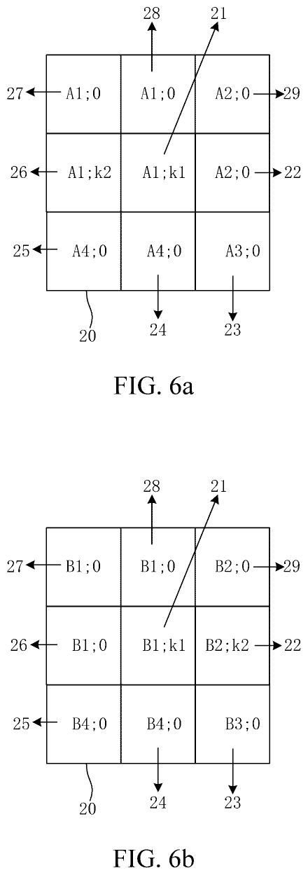

As shown in FIG. 5, FIG. 6a, and FIG. 6b, in some embodiments of the present application, the display panel M2 has the display area AA, and the target pixel unit 11 is adjacent to the edge AA1 of the display area AA, where the first brightness of the specific sub-pixels in at least two calculation blocks 20 of the plurality of calculation blocks 20 correspond to the first brightness of the specific sub-pixels in the same pixel units 10.

In the display panel M2 provided in the present application, since the target pixel unit 11 is adjacent to the edge AA1 of the display area AA, the number of pixel units 10 around the target pixel unit 11 is less than eight. That is, when the plurality of calculation blocks 20 includes the target calculation block 21, the second calculation block 22, the third calculation block 23, the fourth calculation block 24, the fifth calculation block 25, the sixth calculation block 26, the seventh calculation block 27, the eighth calculation block 28, and the ninth calculation block 29, and when the target calculation block 21 corresponds to the target pixel unit 11, at least one of the second calculation block 22, the third calculation block 23, the fourth calculation block 24, the fifth calculation block 25, the sixth calculation block 26, the seventh calculation block 27, the eighth calculation block 28, and the ninth calculation block 29 cannot be in one-to-one correspondence with one of the pixel units 10 around the target pixel unit 11. In this case, the first brightness of the specific sub-pixels in at least two calculation blocks 20 of the plurality of calculation blocks 20 correspond to the first brightness of the specific sub-pixel in the same one of the pixel units 10 to perform replicative extension on the first brightness of the specific sub-pixel in at least one calculation block 20, avoiding the problem of a low second brightness of the specific sub-pixel in the target pixel unit 11 after rendering in the case where the first brightness of the specific sub-pixels in the calculation blocks 20 is determined to be 0 because the target pixel unit 11 is adjacent to the edge AA1 of the display area AA.

In some embodiments of the present application, there is no other calculation block 20 between the two calculation blocks 20 corresponding to the first brightness of the specific sub-pixel in the same one of the pixel units 10.

For example, when the target pixel unit 11 is located at the upper left corner of the display area AA, after performing the replicative extension of the first brightness of the specific sub-pixel in the at least one calculation block 20, the first brightness of the second sub-pixel 102 in the target pixel unit 11 is A1; the first brightness of the second sub-pixel 102 in the second pixel unit 12 is A2; the first brightness of the second sub-pixel 102 in the third pixel unit 13 is A3; the first brightness of the second sub-pixel 102 in the fourth pixel unit 14 is A4; the first brightness of the second sub-pixel 102 in the fifth pixel unit 15 is A4; the first brightness of the second sub-pixel 102 in the sixth pixel unit 16 is A1; the first brightness of the second sub-pixel 102 in the seventh pixel unit 17 is A1; the first brightness of the second sub-pixel 102 in the eighth pixel unit 18 is A1; the first brightness of the second sub-pixel 102 in the ninth pixel unit 19 is A2; the first brightness of the third sub-pixel 103 in the target pixel unit 11 is B1; the first brightness of the third sub-pixel 103 in the second pixel unit 12 is B2; the first brightness of the third sub-pixel 103 in the third pixel unit 13 is B3; the first brightness of the third sub-pixel 103 in the fourth pixel unit 14 is B4; the first brightness of the third sub-pixel 103 in the fifth pixel unit 15 is B4; the first brightness of the third sub-pixel 103 in the sixth pixel unit 16 is B1; the first brightness of the third sub-pixel 103 in the seventh pixel unit 17 is B1; the first brightness of the third sub-pixel 103 in the eighth pixel unit 18 is B1; and the first brightness of the third sub-pixel 103 in the ninth pixel unit 19 is B2.

Note that the content of the replicative extension does not include the compensation coefficients of the specific sub-pixels. In some embodiments of the present application, compensation coefficients of specific sub-pixels in the target calculation block 21, the second calculation block 22, the third calculation block 23, the fourth calculation block 24, the fifth calculation block 25, the sixth calculation block 26, the seventh calculation block 27, the eighth calculation block 28, and the ninth calculation block 29 remain unchanged, that is, when the specific sub-pixels are the second sub-pixels 102, the compensation coefficient of the second sub-pixel 102 of the target calculation block 21 is k1, the compensation coefficient of the second sub-pixel 102 of the sixth calculation block 26 is k2, and the compensation coefficients of the second sub-pixels 102 of the other calculation blocks 20 are all 0; and when the specific sub-pixels are the third sub-pixels 103, the compensation coefficient of the third sub-pixel 103 of the target calculation block 21 is k1, the compensation coefficient of the third sub-pixel 103 of the second calculation block 22 is k2, and the compensation coefficients of the third sub-pixels 103 of the other calculation blocks 20 are all 0.

According to a second aspect, embodiments of the present application provides the sub-pixel rendering method for driving the plurality of pixel units 10 of the display panel, the display panel M2 including the plurality of pixel units 10 sequentially arranged in the first direction X and the second direction Y, the first direction X intersecting the second direction Y, each of the pixel units 10 including three sub-pixels, the three sub-pixels being the first sub-pixel 101, the second sub-pixel 102, and the third sub-pixel 103, respectively, where the first sub-pixel 101 in one pixel unit 10 is disposed on the side of the second sub-pixel 102 and the third sub-pixel 103 facing toward the second direction Y, and the first sub-pixel 101 in the pixel unit 10 adjacent to the one pixel unit 10 is disposed on the side of the second sub-pixel 102 and the third sub-pixel 103 facing opposite to the second direction Y, and the side of each of the first sub-pixels 101 facing toward the first direction X is adjacent to one second sub-pixel 102, the side of each of the first sub-pixels 101 facing opposite to the first direction X is adjacent to one third sub-pixel 103.

In this case the sub-pixel rendering method includes the steps of:
obtaining position information of the target pixel unit 11 and the first brightness of the specific sub-pixel in the target pixel unit 11, and the first brightness of the specific sub-pixel in each pixel unit 10 around the target pixel unit 11, the specific sub-pixels including the second sub-pixels 102 and the third sub-pixels 103;
recalculating the brightness of the specific sub-pixel in the target pixel unit 11 according to the rendering calculation matrix table M321 to output the second brightness of the specific sub-pixel in the target pixel unit 11;
where the rendering calculation matrix table M321 includes the plurality of calculation blocks 20, the second brightness of the specific sub-pixel in the target pixel unit 11 is equal to the sum of the values of the plurality of calculation blocks 20, and the value of each of the calculation blocks 20 is obtained by multiplying the first brightness of the specific sub-pixel of one of the target pixel unit 11 and the pixel units 10 around the target pixel unit 11 by a compensation coefficient, and the values of at least two of the plurality of calculation blocks 20 are greater than 0.

In some embodiments of the present application, the specific sub-pixels include the second sub-pixels 102 and the third sub-pixels 103, and do not include the first sub-pixels 101.

In some embodiments of the present application, when the obtained position information of the target pixel unit 11 is that at least one pixel unit 10 is disposed between the target pixel unit 11 and any edge AA1 of the display area AA, the step of recalculating the brightness of the specific sub-pixel in the target pixel unit 11 according to the rendering calculation matrix table M321 to output the second brightness of the specific sub-pixel in the target pixel unit 11 includes:
recalculating the brightness of the second sub-pixel 102 in the target pixel unit 11, where the compensation coefficient of the second sub-pixel 102 of the target calculation block 21 is k1, the compensation coefficient of the second sub-pixel 102 of the sixth calculation block 26 is k2, k1 and k2 are both greater than 0, the sum of k1 and k2 is equal to 1, and the compensation coefficients of the second sub-pixels 102 of the other calculation blocks 20 are all 0;
recalculating the brightness of the third sub-pixel 103 in the target pixel unit 11, where the compensation coefficient of the third sub-pixel 103 in the target calculation block 21 is k1, the compensation coefficient of the third sub-pixel 103 in the second calculation block 22 is k2, k1 and k2 are both greater than 0, the sum of k1 and k2 is equal to 1, and the compensation coefficients of the third sub-pixels 103 in the other calculation blocks 20 are all 0.

In some embodiments of the present application, when the obtained position information of the target pixel unit 11 is that the target pixel unit 11 is adjacent to the edge AA1 of the display area AA, the step of recalculating the brightness of the specific sub-pixel in the target pixel unit 11 according to the rendering calculation matrix table M321 to output the second brightness of the specific sub-pixel in the target pixel unit 11 includes:
making the first brightness of the specific sub-pixels in at least two calculation blocks 20 of the plurality of calculation blocks 20 to correspond to the first brightness of the specific sub-pixel in the same one of the pixel units 10 to perform replicative extension on the first brightness of the specific sub-pixel in at least one calculation block 20 to avoid the problem of a low second brightness of the specific sub-pixel in the target pixel unit 11 after rendering in the case where the first brightness of the specific sub-pixels in the calculation blocks 20 is determined to be 0 because the target pixel unit 11 is adjacent to the edge AA1 of the display area AA.

### Embodiment 2

According to a first aspect, Embodiment 2 of the present application provides the display device M1 including the display panel M2 and the driving chip M3, where the display panel M2 includes the plurality of pixel units 10 arranged in sequence in the first direction X and the second direction Y, and the first direction X intersects the second direction Y. Each of the pixel units 10 includes three sub-pixels, i.e. the first sub-pixel 101, the second sub-pixel 102, and the third sub-pixel 103, respectively. The first sub-pixel 101 in one of the pixel units 10 is disposed on one side of the second sub-pixel 102 and the third sub-pixel 103 facing toward the second direction Y, and the first sub-pixel 101 in an adjacent one of the pixel units 10 is disposed on one side of the second sub-pixel 102 and the third sub-pixel 103 facing opposite to the second direction Y, and one side of each first sub-pixel 101 facing toward the first direction X is adjacent to one second sub-pixel 102, and one side of each first sub-pixel 101 facing opposite to the first direction X is adjacent to one third sub-pixel 103. The driving chip M3 is electrically connected to the display panel M2, the driving chip M3 includes the first brightness module M31 and the sub-pixel rendering module M32, where the first brightness module M31 outputs the first brightness of a specific sub-pixel in the target pixel unit 11 and the first brightness of a specific sub-pixel in each of the pixel units 10 around the target pixel unit 11 to the sub-pixel rendering module M32, and the specific sub-pixel includes the second sub-pixel 102 and the third sub-pixel 103; and the sub-pixel rendering module M32 recalculates the brightness of the specific sub-pixel in the target pixel unit 11 to output the second brightness of the specific sub-pixel in the target pixel unit 11.

It should be noted that the display device M1 provided in Embodiment 2 of the present application is similar to the display device M1 provided in Embodiment 1 of the present application, and details of the same parts are not described in Embodiment 2 of the present application.

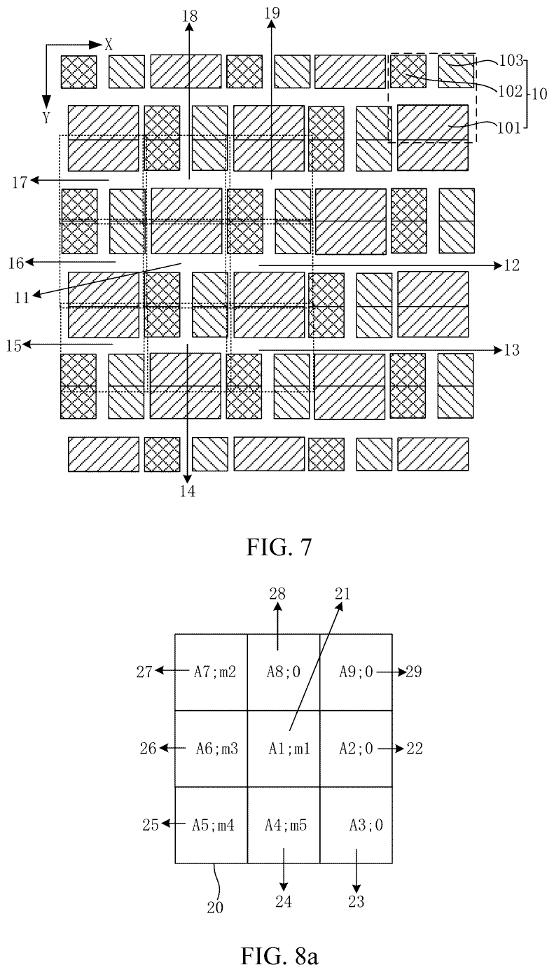

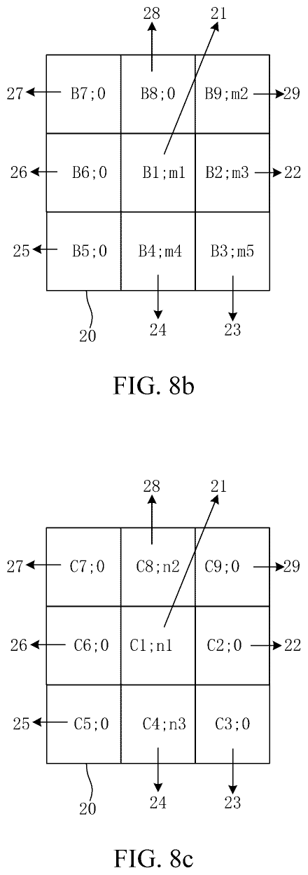

As shown in FIG. 7, FIG. 8a, and FIG. 8b, in some embodiments of the present application, the display panel M2 has the display area AA, at least one of the pixel units 10 is disposed between the target pixel unit 11 and any edge AA1 of the display area AA. The pixel units 10 around the target pixel unit 11 includes the second pixel unit 12, the third pixel unit 13, the fourth pixel unit 14, the fifth pixel unit 15, the sixth pixel unit 16, the seventh pixel unit 17, the eighth pixel unit 18, and the ninth pixel unit 19 arranged in sequence in the clockwise direction, and the second pixel unit 12 is disposed on one side of the target pixel unit 11 facing toward the first direction X. The plurality of calculation blocks 20 includes the target calculation block 21, and the second calculation block 22, the third calculation block 23, the fourth calculation block 24, the fifth calculation block 25, the sixth calculation block 26, the seventh calculation block 27, the eighth calculation block 28, and the ninth calculation block 29 arranged in sequence in the clockwise direction around the target calculation block 21, and the second calculation block 22 is arranged on the side of the target calculation block 21 facing toward the first direction X. In this case the first brightness of the specific sub-pixels in the target calculation block 21, the second calculation block 22, the third calculation block 23, the fourth calculation block 24, the fifth calculation block 25, the sixth calculation block 26, the seventh calculation block 27, the eighth calculation block 28, and the ninth calculation block 29 correspond to the first brightness of the specific sub-pixels in the target pixel unit 11, the second pixel unit 12, the third pixel unit 13, the fourth pixel unit 14, the fifth pixel unit 15, the sixth pixel unit 16, the seventh pixel unit 17, the eighth pixel unit 18, and the ninth pixel unit 19, respectively. When the second sub-pixel 102 and the third sub-pixel 103 in the target pixel unit 11 are disposed on one side of the first sub-pixel 101 facing toward the second direction Y, and when the specific sub-pixels are the second sub-pixels 102, the compensation coefficient of the second sub-pixel 102 of the target calculation block 21 is m1, the compensation coefficient of the second sub-pixel 102 of the seventh calculation block 27 is m2, the compensation coefficient of the second sub-pixel 102 of the sixth calculation block 26 is m3, the compensation coefficient of the second sub-pixel 102 of the fifth calculation block 25 is m4, and the compensation coefficient of the second sub-pixel 102 of the fourth calculation block 24 is m5, where m1, m2, m3, m4, m5 are all greater than 0, the sum of m1, m2, m3, m4, m5 is equal to 1, and the compensation coefficients of the second sub-pixels 102 of the other calculation blocks 20 are all 0. When the specific sub-pixels are the third sub-pixels 103, the compensation coefficient of the third sub-pixel 103 of the target calculation block 21 is m1, the compensation coefficient of the third sub-pixel 103 of the ninth calculation block 29 is m2, the compensation coefficient of the third sub-pixel 103 of the second calculation block 22 is m3, the compensation coefficient of the third sub-pixel 103 of the fourth calculation block 24 is m4, and the compensation coefficient of the third sub-pixel 103 of the third calculation block 23 is m5, where m1, m2, m3, m4, m5 are all greater than 0, the sum of m1, m2, m3, m4, m5 is equal to 1, and the compensation coefficients of the third sub-pixels 103 of the other calculation blocks 20 are all 0.

In the display panel M2 provided in the present application, when the second sub-pixel 102 and the third sub-pixel 103 in the target pixel unit 11 are disposed on one side of the first sub-pixel 101 facing toward the second direction Y, and when the specific sub-pixels are the second sub-pixels 102, the compensation coefficients of the second sub-pixels 102 of the other calculation blocks 20 except the target calculation block 21, the seventh calculation block 27, the sixth calculation block 26, the fifth calculation block 25, and the fourth calculation block 24 are all 0, that is, when the rendering compensation is performed on the second sub-pixel 102 in the target pixel unit 11, the second brightness of the second sub-pixel 102 in the target pixel unit 11 can be affected by the first brightness of the second sub-pixel 102 in the target pixel unit 11 corresponding to the target calculation block 21, the first brightness of the second sub-pixel 102 in the seventh pixel unit 17 corresponding to the seventh calculation block 27, the first brightness of the second sub-pixel 102 in the sixth pixel unit 16 corresponding to the sixth calculation block 26, the first brightness of the second sub-pixel 102 in the fifth pixel unit 15 corresponding to the fifth calculation block 25, and the first brightness of the second sub-pixel 102 in the fourth pixel unit 14 corresponding to the fourth calculation block 24.

Similarly, when the second sub-pixel 102 and the third sub-pixel 103 in the target pixel unit 11 are disposed on one side of the first sub-pixel 101 facing toward the second direction Y, and when the specific sub-pixels are the third sub-pixels 103, the compensation coefficients of the third sub-pixels 103 of the other calculation blocks 20 except the target calculation block 21, the ninth calculation block 29, the second calculation block 22, the fourth calculation block 24, and the third calculation block 23 are all 0, that is, when the rendering compensation is performed on the third sub-pixel 103 in the target pixel unit 11, the second brightness of the third sub-pixel 103 in the target pixel unit 11 can be affected by the first brightness of the third sub-pixel 103 in the target pixel unit 11 corresponding to the target calculation block 21, the first brightness of the third sub-pixel 103 in the ninth pixel unit 19 corresponding to the ninth calculation block 29, the first brightness of the third sub-pixel 103 in the second pixel unit 12 corresponding to the second calculation block 22, the first brightness of the third sub-pixel 103 in the fourth pixel unit 14 corresponding to the fourth calculation block 24 and the first brightness of the third sub-pixel 103 in the third pixel unit 13 corresponding to the third calculation block 23.

In summary, when the rendering compensation is performed on the second sub-pixel 102 and the third sub-pixel 103 in the target pixel unit 11, the second sub-pixel 102 in the target pixel unit 11 can be shared by the target pixel unit 11, the seventh pixel unit 17, the sixth pixel unit 16, the fifth pixel unit 15, and the fourth pixel unit 14; and the third sub-pixel 103 in the target pixel unit 11 can be shared by the target pixel unit 11, the ninth pixel unit 19, the second pixel unit 12, the fourth pixel unit 14, and the third pixel unit 13, so that the display of the target pixel unit 11 is more suitable for the human-eye color mixing effect, thereby improving the display effect of the display panel M2. At the same time, the rendering range of the sub-pixel rendering module M32 can be expanded so that when the specific sub-pixel of the target pixel unit 11 is displaying, the specific sub-pixels of the plurality of pixel units 10 around the target pixel unit 11 also perform the display function, thereby solving the problem that the life of the display panel M2 decreases due to long-time display of one single pixel unit 10.

In some embodiments of the present application, m1 is ¼, m2 is ¼, m3 is ⅛, m4 is ⅛, and m5 is ¼.

In some embodiments of the present application, the first brightness of the second sub-pixel 102 in the target pixel unit 11 is A 1; the first brightness of the second sub-pixel 102 in the second pixel unit 12 is A2; the first brightness of the second sub-pixel 102 in the third pixel unit 13 is A3; the first brightness of the second sub-pixel 102 in the fourth pixel unit 14 is A4; the first brightness of the second sub-pixel 102 in the fifth pixel unit 15 is A5; the first brightness of the second sub-pixel 102 in the sixth pixel unit 16 is A6; the first brightness of the second sub-pixel 102 in the seventh pixel unit 17 is A7; the first brightness of the second sub-pixel 102 in the eighth pixel unit 18 is A8; and the first brightness of the second sub-pixel 102 in the ninth pixel unit 19 is A9. Then, when the second sub-pixel 102 and the third sub-pixel 103 in the target pixel unit 11 are disposed on the side of the first sub-pixel 101 facing toward the second direction Y, the second brightness of the second sub-pixel 102 in the target pixel unit 11 is the sum of the product of A1 and m1, the product of A7 and m2, the product of A6 and m3, the product of A5 and m4, and the product of A4 and m5.

In some embodiments of the present application, the first brightness of the third sub-pixel 103 in the target pixel unit 11 is B1; the first brightness of the third sub-pixel 103 in the second pixel unit 12 is B2; the first brightness of the third sub-pixel 103 in the third pixel unit 13 is B3; the first brightness of the third sub-pixel 103 in the fourth pixel unit 14 is B4; the first brightness of the third sub-pixel 103 in the fifth pixel unit 15 is B5; the first brightness of the third sub-pixel 103 in the sixth pixel unit 16 is B6; the first brightness of the third sub-pixel 103 in the seventh pixel unit 17 is B7; the first brightness of the third sub-pixel 103 in the eighth pixel unit 18 is B8; and the first brightness of the third sub-pixel 103 in the ninth pixel unit 19 is B9. Then, when the second sub-pixel 102 and the third sub-pixel 103 in the target pixel unit 11 are disposed on the side of the first sub-pixel 101 facing toward the second direction Y, the second brightness of the third sub-pixel 103 in the target pixel unit 11 is the sum of the product of B1 and m1, the product of B9 and m2, the product of B2 and m3, the product of B4 and m4, and the product of B3 and m5.

As shown in FIG. 8c, in some embodiments of the present application, when the second sub-pixel 102 and the third sub-pixel 103 in the target pixel unit 11 are disposed on the side of the first sub-pixel 101 facing toward the second direction Y, the specific sub-pixels include the first sub-pixels 101. And when the specific sub-pixels are the first sub-pixels 101, the compensation coefficient of the first sub-pixel 101 of the target calculation block 21 is n1, the compensation coefficient of the first sub-pixel 101 of the eighth calculation block 28 is n2, the compensation coefficient of the first sub-pixel 101 of the fourth calculation block 24 is n3, where n1, n2, n3 are all greater than 0, the sum of n1, n2, n3 is equal to 1, and the compensation coefficients of the third sub-pixel 103 of the other calculation blocks 20 are all 0.

In the display panel M2 provided in the present application, since the rendering range of the sub-pixel rendering module M32 covers the three first sub-pixels 101 arranged in sequence in the second direction Y, accordingly, the present application can further improve the display effect of the display panel M2 by performing the rendering compensation on the brightness of the first sub-pixel 101 in the target pixel unit 11, and solve the problem that the life of the display panel M2 decreases due to long-time display of the single pixel unit 10.

In some embodiments of the present application, the first brightness of the first sub-pixel 101 in the target pixel unit 11 is C1; the first brightness of the first sub-pixel 101 in the second pixel unit 12 is C2; the first brightness of the first sub-pixel 101 in the third pixel unit 13 is C3; the first brightness of the first sub-pixel 101 in the fourth pixel unit 14 is C4; the first brightness of the first sub-pixel 101 in the fifth pixel unit 15 is C5; the first brightness of the first sub-pixel 101 in the sixth pixel unit 16 is C6; the first brightness of the first sub-pixel 101 in the seventh pixel unit 17 is C7; the first brightness of the first sub-pixel 101 in the eighth pixel unit 18 is C8; and the first brightness of the first sub-pixel 101 in the ninth pixel unit 19 is C9. Then, when the second sub-pixel 102 and the third sub-pixel 103 in the target pixel unit 11 are disposed on the side of the first sub-pixel 101 facing toward the second direction Y, the second brightness of the first sub-pixel 101 in the target pixel unit 11 is the sum of the product of C1 and n1, the product of C8 and n2, and the product of C4 and n3.

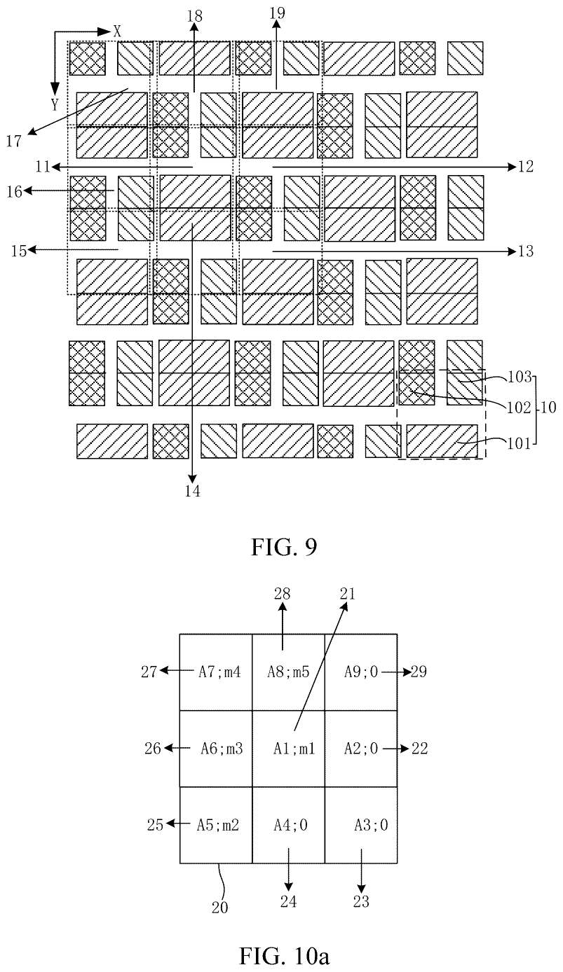

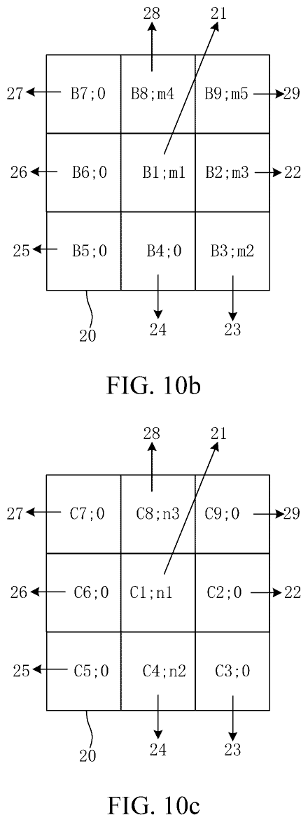

As shown in FIG. 9, FIG. 10a, and FIG. 10b, in some embodiments of the present application, when the second sub-pixel 102 and the third sub-pixel 103 in the target pixel unit 11 are disposed on the side of the first sub-pixel 101 facing opposite to the second direction Y, and when the specific sub-pixels are the second sub-pixels 102, the compensation coefficient of the second sub-pixel 102 of the target calculation block 21 is m1, the compensation coefficient of the second sub-pixel 102 of the fifth calculation block 25 is m2, the compensation coefficient of the second sub-pixel 102 of the sixth calculation block 26 is m3, the compensation coefficient of the second sub-pixel 102 of the seventh calculation block 27 is m4, the compensation coefficient of the second sub-pixel 102 of the eighth calculation block 28 is m5, where m1, m2, m3, m4, m5 are all greater than 0, and the sum of m1, m2, m3, m4, m5 is equal to 1. The compensation coefficients of the second sub-pixels 102 of the other calculation blocks 20 are all 0. When the specific sub-pixels are the third sub-pixels 103, the compensation coefficient of the third sub-pixel 103 of the target calculation block 21 is m1, the compensation coefficient of the third sub-pixel 103 of the third calculation block 23 is m2, the compensation coefficient of the third sub-pixel 103 of the second calculation block 22 is m3, the compensation coefficient of the third sub-pixel 103 of the eighth calculation block 28 is m4, the compensation coefficient of the third sub-pixel 103 of the ninth calculation block 29 is m5, where m1, m2, m3, m4, m5 are all greater than 0, the sum of m1, m2, m3, m4, m5 is equal to 1, and the compensation coefficients of the third sub-pixels 103 of the other calculation blocks 20 are all 0.

In the display panel M2 provided in the present application, when the second sub-pixel 102 and the third sub-pixel 103 in the target pixel unit 11 are disposed on the side of the first sub-pixel 101 facing opposite to the second direction Y, and when the specific sub-pixels are the second sub-pixels 102, the compensation coefficients of the other calculation blocks 20 except the target calculation block 21, the fifth calculation block 25, the sixth calculation block 26, the seventh calculation block 27, and the eighth calculation block 28 are all 0. That is, when the rendering compensation is performed on the second sub-pixel 102 in the target pixel unit 11, the second brightness of the second sub-pixel 102 in the target pixel unit 11 can be affected by the first brightness of the second sub-pixel 102 in the target pixel unit 11 corresponding to the target calculation block 21, the first brightness of the second sub-pixel 102 in the fifth pixel unit 15 corresponding to the fifth calculation block 25, the first brightness of the second sub-pixel 102 in the sixth pixel unit 16 corresponding to the sixth calculation block 26, the first brightness of the second sub-pixel 102 in the seventh pixel unit 17 corresponding to the seventh calculation block 27 and the first brightness of the second sub-pixel 102 in the eighth pixel unit 18 corresponding to the eighth calculation block 28.

In the display panel M2 provided in the present application, when the second sub-pixel 102 and the third sub-pixel 103 in the target pixel unit 11 are disposed on the side of the first sub-pixel 101 facing opposite to the second direction Y, and when the specific sub-pixels are the third sub-pixels 103, the compensation coefficients of the third sub-pixels 103 of the other calculation blocks 20 except the target calculation block 21, the third calculation block 23, the second calculation block 22, the eighth calculation block 28, and the ninth calculation block 29 are all 0. That is, when the rendering compensation is performed on the third sub-pixel 103 in the target pixel unit 11, the second brightness of the third sub-pixel 103 in the target pixel unit 11 can be affected by the first brightness of the third sub-pixel 103 in the target pixel unit 11 corresponding to the target calculation block 21, the first brightness of the third sub-pixel 103 in the third pixel unit 13 corresponding to the third calculation block 23, the first brightness of the third sub-pixel 103 in the second pixel unit 12 corresponding to the second calculation block 22, the first brightness of the third sub-pixel 103 in the eighth pixel unit 18 corresponding to the eighth calculation block 28, and the first brightness of the third sub-pixel 103 in the ninth pixel unit 19 corresponding to the ninth calculation block 29.

In summary, when the rendering compensation is performed on the second sub-pixel 102 and the third sub-pixel 103 in the target pixel unit 11, the second sub-pixel 102 in the target pixel unit 11 can be shared by the target pixel unit 11, the fifth pixel unit 15, the sixth pixel unit 16, the seventh pixel unit 17, and the eighth pixel unit 18, and the third sub-pixel 103 in the target pixel unit 11 can be shared by the target pixel unit 11, the third pixel unit 13, the second pixel unit 12, the eighth pixel unit 18, and the ninth pixel unit 19, so that the display of the target pixel unit 11 is more suitable for the human-eye color mixing effect, thereby improving the display effect of the display panel M2. At the same time, the rendering range of the sub-pixel rendering module M32 can be expanded so that when the specific sub-pixel of the target pixel unit 11 is displaying, the specific sub-pixels of the plurality of pixel units 10 around the target pixel unit 11 also perform the display function, thereby solving the problem that the life of the display panel M2 decreases due to long-time display of one single pixel units 10.

In some embodiments of the present application, m1 is ¼, m2 is ¼, m3 is ⅛, m4 is ⅛, and m5 is ¼.

In some embodiments of the present application, the first brightness of the second sub-pixel 102 in the target pixel unit 11 is A1; the first brightness of the second sub-pixel 102 in the second pixel unit 12 is A2; the first brightness of the second sub-pixel 102 in the third pixel unit 13 is A3; the first brightness of the second sub-pixel 102 in the fourth pixel unit 14 is A4; the first brightness of the second sub-pixel 102 in the fifth pixel unit 15 is A5; the first brightness of the second sub-pixel 102 in the sixth pixel unit 16 is A6; the first brightness of the second sub-pixel 102 in the seventh pixel unit 17 is A7; the first brightness of the second sub-pixel 102 in the eighth pixel unit 18 is A8; and the first brightness of the second sub-pixel 102 in the ninth pixel unit 19 is A9. Then, when the second sub-pixel 102 and the third sub-pixel 103 in the target pixel unit 11 are disposed on the side of the first sub-pixel 101 facing opposite to the second direction Y, the second brightness of the second sub-pixel 102 in the target pixel unit 11 is the sum of the product of A1 and m1, the product of A5 and m2, the product of A6 and m3, the product of A7 and m4, and the product of A8 and m5.

In some embodiments of the present application, the first brightness of the third sub-pixel 103 in the target pixel unit 11 is B1; the first brightness of the third sub-pixel 103 in the second pixel unit 12 is B2; the first brightness of the third sub-pixel 103 in the third pixel unit 13 is B3; the first brightness of the third sub-pixel 103 in the fourth pixel unit 14 is B4; the first brightness of the third sub-pixel 103 in the fifth pixel unit 15 is B5; the first brightness of the third sub-pixel 103 in the sixth pixel unit 16 is B6; the first brightness of the third sub-pixel 103 in the seventh pixel unit 17 is B7; the first brightness of the third sub-pixel 103 in the eighth pixel unit 18 is B8; and the first brightness of the third sub-pixel 103 in the ninth pixel unit 19 is B9. Then, when the second sub-pixel 102 and the third sub-pixel 103 in the target pixel unit 11 are disposed on the side of the first sub-pixel 101 facing opposite to the second direction Y, the second brightness of the third sub-pixel 103 in the target pixel unit 11 is the sum of the product of B1 and m1, the product of B3 and m2, the product of B2 and m3, the product of B8 and m4, and the product of B9 and m5.

As shown in FIG. 10c, in some embodiments of the present application, when the second sub-pixel 102 and the third sub-pixel 103 in the target pixel unit 11 are disposed on the side of the first sub-pixel 101 facing opposite to the second direction Y, the specific sub-pixels include the first sub-pixels 101. And when the specific sub-pixels are the first sub-pixels 101, the compensation coefficient of the first sub-pixel 101 of the target calculation block 21 is n1, the compensation coefficient of the first sub-pixel 101 of the fourth calculation block 24 is n2, the compensation coefficients of the first sub-pixel 101 of the eighth calculation block 28 are n3 where n1, n2, n3 are all greater than 0, the sum of n1, n2, n3 is equal to 1, and the compensation coefficients of the third sub-pixel 103 of the other calculation blocks 20 are all 0.

In the display panel M2 provided in the present application, since the rendering range of the sub-pixel rendering module M32 covers the three first sub-pixels 101 arranged in sequence in the second direction Y, accordingly, the present application can further improve the display effect of the display panel M2 by performing the rendering compensation on the brightness of the first sub-pixel 101 in the target pixel unit 11, and solve the problem that the life of the display panel M2 decreases due to long-time display of the single pixel unit 10.

In some embodiments of the present application, the first brightness of the first sub-pixel 101 in the target pixel unit 11 is C1; the first brightness of the first sub-pixel 101 in the second pixel unit 12 is C2; the first brightness of the first sub-pixel 101 in the third pixel unit 13 is C3; the first brightness of the first sub-pixel 101 in the fourth pixel unit 14 is C4; the first brightness of the first sub-pixel 101 in the fifth pixel unit 15 is C5; the first brightness of the first sub-pixel 101 in the sixth pixel unit 16 is C6; the first brightness of the first sub-pixel 101 in the seventh pixel unit 17 is C7; the first brightness of the first sub-pixel 101 in the eighth pixel unit 18 is C8; and the first brightness of the first sub-pixel 101 in the ninth pixel unit 19 is C9. Then, when the second sub-pixel 102 and the third sub-pixel 103 in the target pixel unit 11 are disposed on the side of the first sub-pixel 101 facing toward the second direction Y, the second brightness of the first sub-pixel 101 in the target pixel unit 11 is the sum of the product of C1 and n1, the product of C4 and n2, and the product of C8 and n3.

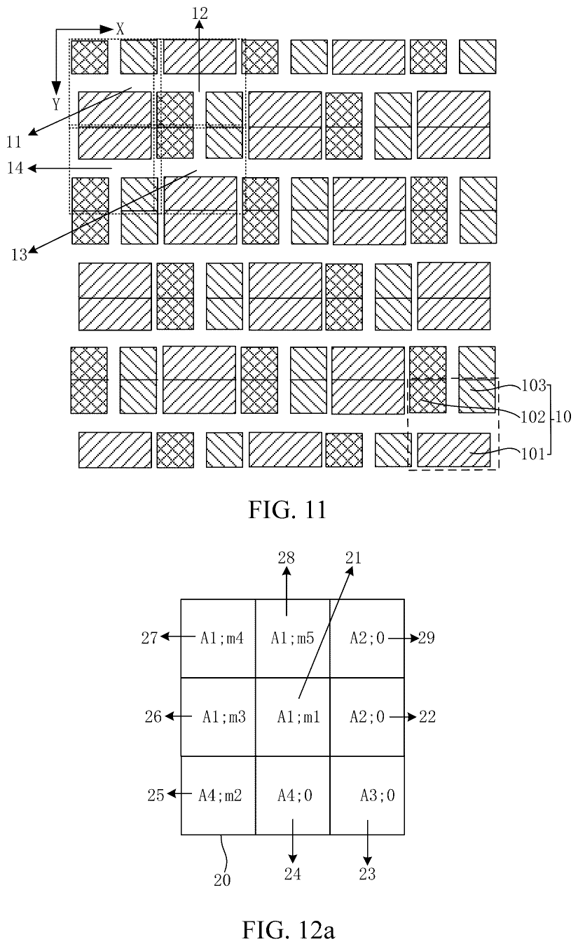

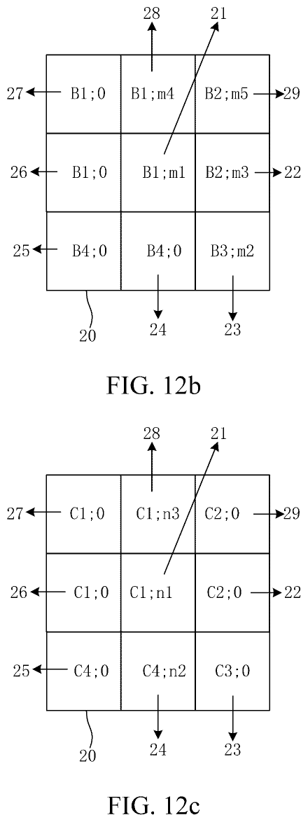

As shown in FIG. 11, FIG. 12a, FIG. 12b, and FIG. 12c, in some embodiments of the present application, the display panel M2 has the display area AA, and the target pixel unit 11 is adjacent to an edge AA1 of the display area AA. The first brightness of the specific sub-pixels in at least two calculation blocks 20 of the plurality of calculation blocks 20 correspond to the first brightness of the specific sub-pixels in the same pixel units 10.

In the display panel M2 provided in the present application, since the target pixel unit 11 is adjacent to the edge AA1 of the display area AA, the number of pixel units 10 around the target pixel unit 11 is less than eight. That is, when the plurality of calculation blocks 20 include the target calculation block 21, the second calculation block 22, the third calculation block 23, the fourth calculation block 24, the fifth calculation block 25, the sixth calculation block 26, the seventh calculation block 27, the eighth calculation block 28 and the ninth calculation block 29, and the target calculation block 21 corresponds to the target pixel unit 11, at least one of the second calculation block 22, the third calculation block 23, the fourth calculation block 24, the fifth calculation block 25, the sixth calculation block 26, the seventh calculation block 27, the eighth calculation block 28 and the ninth calculation block 29 cannot be in one-to-one correspondence with the pixel units 10 around the target pixel unit 11. In this case, the first brightness of the specific sub-pixels in at least two calculation blocks 20 of the plurality of calculation blocks 20 correspond to the first brightness of the specific sub-pixel in the same one of the pixel units 10 to perform replicative extension on the first brightness of the specific sub-pixels in at least one calculation block 20, avoiding the problem of a low second brightness of the specific sub-pixel in the target pixel unit 11 after rendering in the case where the first brightness of the specific sub-pixels in the calculation blocks 20 is determined to be 0 because the target pixel unit 11 is adjacent to the edge AA1 of the display area AA.

In some embodiments of the present application, no other calculation block 20 is disposed between two calculation blocks 20 corresponding to the first brightness of the specific sub-pixel in the same one of the pixel units 10.

For example, when the target pixel unit 11 is located at the upper left corner of the display area AA, after performing the replicative extension of the first brightness of the specific sub-pixel in the at least one calculation block 20, the first brightness of the second sub-pixel 102 in the target pixel unit 11 is A1; the first brightness of the second sub-pixel 102 in the second pixel unit 12 is A2; the first brightness of the second sub-pixel 102 in the third pixel unit 13 is A3; the first brightness of the second sub-pixel 102 in the fourth pixel unit 14 is A4; the first brightness of the second sub-pixel 102 in the fifth pixel unit 15 is A4; the first brightness of the second sub-pixel 102 in the sixth pixel unit 16 is A1; the first brightness of the second sub-pixel 102 in the seventh pixel unit 17 is A1; the first brightness of the second sub-pixel 102 in the eighth pixel unit 18 is A1; the first brightness of the second sub-pixel 102 in the ninth pixel unit 19 is A2; the first brightness of the third sub-pixel 103 in the target pixel unit 11 is B1; the first brightness of the third sub-pixel 103 in the second pixel unit 12 is B2; the first brightness of the third sub-pixel 103 in the third pixel unit 13 is B3; the first brightness of the third sub-pixel 103 in the fourth pixel unit 14 is B4; the first brightness of the third sub-pixel 103 in the fifth pixel unit 15 is B4; the first brightness of the third sub-pixel 103 in the sixth pixel unit 16 is B1; the first brightness of the third sub-pixel 103 in the seventh pixel unit 17 is B1; the first brightness of the third sub-pixel 103 in the eighth pixel unit 18 is B1; the first brightness of the third sub-pixel 103 in the ninth pixel unit 19 is B2; the first brightness of the first sub-pixel 101 in the target pixel unit 11 is C1; the first brightness of the first sub-pixel 101 in the second pixel unit 12 is C2; the first brightness of the first sub-pixel 101 in the third pixel unit 13 is C 3; the first brightness of the first sub-pixel 101 in the fourth pixel unit 14 is C4; the first brightness of the first sub-pixel 101 in the fifth pixel unit 15 is C4; the first brightness of the first sub-pixel 101 in the sixth pixel unit 16 is C1; the first brightness of the first sub-pixel 101 in the seventh pixel unit 17 is C1; the first brightness of the first sub-pixel 101 in the eighth pixel unit 18 is C1; and the first brightness of the first sub-pixel 101 in the ninth pixel unit 19 is C2.

Note that the content of the replicative extension does not include the compensation coefficients of the specific sub-pixels. In some embodiments of the present application, for example, when the second sub-pixel 102 and the third sub-pixel 103 in the target pixel unit 11 are disposed on the side of the first sub-pixel 101 facing toward the second direction Y, the compensation coefficients of the specific sub-pixels in the target calculation block 21, the second calculation block 22, the third calculation block 23, the fourth calculation block 24, the fifth calculation block 25, the sixth calculation block 26, the seventh calculation block 27, the eighth calculation block 28, and the ninth calculation block 29 remain unchanged. That is, when the specific sub-pixels are the second sub-pixels 102, the compensation coefficient of the second sub-pixel 102 of the target calculation block 21 is m1, the compensation coefficient of the second sub-pixel 102 of the fifth calculation block 25 is m2, the compensation coefficient of the second sub-pixel 102 of the sixth calculation block 26 is m3, the compensation coefficient of the second sub-pixel 102 of the seventh calculation block 27 is m4, and the compensation coefficient of the second sub-pixel 102 of the eighth calculation block 28 is m5, and the compensation coefficients of the second sub-pixels 102 of the other calculation blocks 20 are all 0. When the specific sub-pixels are the third sub-pixels 103, the compensation coefficient of the third sub-pixel 103 of the target calculation block 21 is m1, the compensation coefficient of the third sub-pixel 103 of the third calculation block 23 is m2, the compensation coefficient of the third sub-pixel 103 of the second calculation block 22 is m3, the compensation coefficient of the third sub-pixel 103 of the eighth calculation block 28 is m4, the compensation coefficient of the third sub-pixel 103 of the ninth calculation block 29 is m5, and the compensation coefficients of the third sub-pixels 103 of the other calculation blocks 20 are all 0. When the specific sub-pixels are the first sub-pixels 101, the compensation coefficient of the first sub-pixel 101 of the target calculation block 21 is n1, the compensation coefficient of the first sub-pixel 101 of the fourth calculation block 24 is n2, the compensation coefficient of the first sub-pixel 101 of the eighth calculation block 28 is n3, and the compensation coefficients of the third sub-pixels 103 of the other calculation blocks 20 are all 0.

According to a second aspect, embodiments of the present application provide the sub-pixel rendering method for driving the plurality of pixel units 10 of the display panel, the display panel M2 including the plurality of pixel units 10 sequentially arranged in the first direction X and the second direction Y, the first direction X intersecting the second direction Y, each of the pixel units 10 including three sub-pixels, the three sub-pixels being the first sub-pixel 101, the second sub-pixel 102, and the third sub-pixel 103, respectively, wherein the first sub-pixel 101 in one pixel unit 10 is disposed on the side of the second sub-pixel 102 and the third sub-pixel 103 facing toward the second direction Y, the first sub-pixel 101 in the pixel unit 10 adjacent to the one pixel units 10 is disposed on the side of the second sub-pixel 102 and the third sub-pixel 103 facing opposite to the second direction Y, and the side of each of the first sub-pixels 101 facing toward the first direction X is adjacent to one second sub-pixel 102 and the side of each of the first sub-pixels 101 facing opposite to the first direction X is adjacent to one third sub-pixel 103.

In this case the sub-pixel rendering method includes the steps of:
obtaining position information of the target pixel unit 11 and the first brightness of the specific sub-pixel in the target pixel unit 11, and the first brightness of the specific sub-pixel in each pixel unit 10 around the target pixel unit 11, the specific sub-pixels including the second sub-pixels 102 and the third sub-pixels 103;
recalculating the brightness of the specific sub-pixel in the target pixel unit 11 according to the rendering calculation matrix table M321 to output the second brightness of the specific sub-pixel in the target pixel unit 11;
where the rendering calculation matrix table M321 includes the plurality of calculation blocks 20, the second brightness of the specific sub-pixel in the target pixel unit 11 is equal to the sum of the values of the plurality of calculation blocks 20. And the value of each of the calculation blocks 20 are obtained by multiplying the first brightness of the specific sub-pixel of one of the target pixel unit 11 and the pixel units 10 around the target pixel unit 11 by a compensation coefficient, and the values of at least two of the plurality of calculation blocks 20 are greater than 0.

In some embodiments of the present application, the specific sub-pixels include the first sub-pixels 101, the second sub-pixels 102, and the third sub-pixels 103.

In some embodiments of the present application, when the obtained position information of the target pixel unit 11 is that at least one pixel unit 10 is disposed between the target pixel unit 11 and any edge AA1 of the display area AA, and the second sub-pixel 102 and the third sub-pixel 103 in the target pixel unit 11 are disposed on one side of the first sub-pixel 101 facing toward the second direction Y, the step of recalculating the brightness of the specific sub-pixel in the target pixel unit 11 according to the rendering calculation matrix table M321 to output the second brightness of the specific sub-pixel in the target pixel unit 11 includes:
recalculating the brightness of the first sub-pixel 101 in the target pixel unit 11, where the compensation coefficient of the first sub-pixel 101 of the target calculation block 21 is n1, the compensation coefficient of the first sub-pixel 101 of the eighth calculation block 28 is n2, the compensation coefficient of the first sub-pixel 101 of the fourth calculation block 24 is n3, n1, n2 and n3 are all greater than 0, the sum of n1, n2, and n3 is equal to 1, and the compensation coefficients of the third sub-pixels 103 of the other calculation blocks 20 are all 0;
recalculating the brightness of the second sub-pixel 102 in the target pixel unit 11, where the compensation coefficient of the second sub-pixel 102 in the target calculation block 21 is m1, the compensation coefficient of the second sub-pixel 102 in the seventh calculation block 27 is m2, the compensation coefficient of the second sub-pixel 102 in the sixth calculation block 26 is m3, the compensation coefficient of the second sub-pixel 102 in the fifth calculation block 25 is m4, the compensation coefficient of the second sub-pixel 102 in the fourth calculation block 24 is m5, m1, m2, m3, m4 and m5 are all greater than 0, the sum of m1, m2, m3, m4, m5 is equal to 1, and the compensation coefficients of the second sub-pixels 102 in the other calculation blocks 20 are all 0;
recalculating the brightness of the third sub-pixel 132 in the target pixel unit 11, where the compensation coefficient of the third sub-pixel 103 in the target calculation block 21 is m1, the compensation coefficient of the third sub-pixel 103 in the ninth calculation block 29 is m2, the compensation coefficient of the third sub-pixel 103 in the second calculation block 22 is m3, the compensation coefficient of the third sub-pixel 103 in the fourth calculation block 24 is m4, the compensation coefficient of the third sub-pixel 103 in the third calculation block 23 is m5, m1, m2, m3, m4, m5 are all greater than 0, the sum of m1, m2, m3, m4, m5 is equal to 1, and the compensation coefficients of the third sub-pixels 103 in the other calculation blocks 20 are all 0.

In some embodiments of the present application, when the obtained position information of the target pixel unit 11 is that at least one pixel unit 10 is disposed between the target pixel unit 11 and any edge AA1 of the display area AA, and when the second sub-pixel 102 and the third sub-pixel 103 in the target pixel unit 11 are disposed on the side of the first sub-pixel 101 facing opposite to the second direction Y, the step of recalculating the brightness of the specific sub-pixel in the target pixel unit 11 according to the rendering calculation matrix table M321 to output the second brightness of the specific sub-pixel in the target pixel unit 11 includes:
recalculating the brightness of the first sub-pixel 101 in the target pixel unit 11, where the compensation coefficient of the first sub-pixel 101 in the target calculation block 21 is n1, the compensation coefficient of the first sub-pixel 101 in the fourth calculation block 24 is n2, the compensation coefficient of the first sub-pixel 101 in the eighth calculation block 28 is n3, n1, n2 and n3 are all greater than 0, the sum of n1, n2, and n3 is equal to 1, and the compensation coefficients of the third sub-pixels 103 in the other calculation blocks 20 are all 0;
recalculating the brightness of the second sub-pixel 102 in the target pixel unit 11, where the compensation coefficient of the second sub-pixel 102 in the target calculation block 21 is m1, the compensation coefficient of the second sub-pixel 102 in the fifth calculation block 25 is m2, the compensation coefficient of the second sub-pixel 102 in the sixth calculation block 26 is m3, the compensation coefficient of the second sub-pixel 102 in the seventh calculation block 27 is m4, the compensation coefficient of the second sub-pixel 102 in the eighth calculation block 28 is m5, m1, m2, m3, m4, m5 are all greater than 0, the sum of m1, m2, m3, m4, m5 is equal to 1, and the compensation coefficients of the second sub-pixels 102 in the other calculation blocks 20 are all 0;
recalculating the brightness of the third sub-pixel 132 in the target pixel unit 11, where the compensation coefficient of the third sub-pixel 103 in the target calculation block 21 is m1, the compensation coefficient of the third sub-pixel 103 in the third calculation block 23 is m2, the compensation coefficient of the third sub-pixel 103 in the second calculation block 22 is m3, the compensation coefficient of the third sub-pixel 103 in the eighth calculation block 28 is m4, the compensation coefficient of the third sub-pixel 103 in the ninth calculation block 29 is m5, m1, m2, m3, m4, m5 are all greater than 0, the sum of m1, m2, m3, m4, m5 is equal to 1, and the compensation coefficients of the third sub-pixels 103 in the other calculation blocks 20 are all 0.

In some embodiments of the present application, when the obtained position information of the target pixel unit 11 is that the target pixel unit 11 is adjacent to the edge AA1 of the display area AA, the step of recalculating the brightness of the specific sub-pixel in the target pixel unit 11 according to the rendering calculation matrix table M321 to output the second brightness of the specific sub-pixel in the target pixel unit 11 includes:
the first brightness of the specific sub-pixels in at least two of the plurality of calculation blocks 20 corresponds to the first brightness of the specific sub-pixels in the same pixel units 10.

In summary, the present application provides a display device and a sub-pixel rendering method, the display device including a display panel and a driving chip electrically connected to the display panel. The display panel includes a plurality of pixel units arranged in sequence in a first direction and a second direction, the first direction intersects the second direction, each of the pixel units includes three sub-pixels of different colors, the three sub-pixels being a first sub-pixel, a second sub-pixel and a third sub-pixel, respectively, wherein a first sub-pixel in one of the pixel units is disposed on one side of the second sub-pixel and the third sub-pixel facing toward the second direction, a first sub-pixel in an adjacent one of the pixel units is disposed on one side of the second sub-pixel and the third sub-pixel facing opposite to the second direction, one side of each first sub-pixel facing toward the first direction is adjacent to one second sub-pixel, and one side of each first sub-pixel facing opposite to the first direction is adjacent to one third sub-pixel; the driving chip includes a first brightness module and a sub-pixel rendering module, wherein the first brightness module outputs a first brightness of a specific sub-pixel in a target pixel unit and a first brightness of a specific sub-pixel in each of the pixel units around the target pixel unit to the sub-pixel rendering module, the specific sub-pixels include the second sub-pixels and the third sub-pixels; the sub-pixel rendering module recalculates the brightness of the specific sub-pixel in the target pixel unit to output a second brightness of the specific sub-pixel in the target pixel unit, thereby mitigating the color edge effect and improving the display effect of the display panel.

The above describes in detail the display device and the sub-pixel rendering method according to one or more embodiments of the present application. Specific examples are used to illustrate the principles and embodiments of the present application. The description of the above embodiments is merely provided to help understand the method and the core idea of the present application. At the same time, variations will occur to those skilled in the art in both the detailed description and the scope of application in accordance with the teachings of the present application. In view of the foregoing, the present description should not be construed as limiting the application.

1. A display device, wherein the display device comprises:
a display panel comprising a plurality of pixel units arranged in sequence in a first direction and a second direction, the first direction intersecting the second direction, each of the pixel units comprising three sub-pixels of different colors, the three sub-pixels being a first sub-pixel, a second sub-pixel and a third sub-pixel, respectively, wherein the first sub-pixel in one of the pixel units is disposed on one side of the second sub-pixel and the third sub-pixel facing toward the second direction, the first sub-pixel in an adjacent one of the pixel units is disposed on one side of the second sub-pixel and the third sub-pixel facing opposite to the second direction, one side of each first sub-pixel facing toward the first direction is adjacent to the second sub-pixel in one of the pixel units, and one side of each first sub-pixel facing opposite to the first direction is adjacent to the third sub-pixel in one of the pixel units;
a driving chip electrically connected to the display panel, the driving chip comprising a first brightness module and a sub-pixel rendering module, wherein the first brightness module outputs a first brightness of a specific one of the sub-pixels in a target pixel unit of the pixel units and a first brightness of a specific one of the sub-pixels in each of the pixel units around the target pixel unit to the sub-pixel rendering module, the specific sub-pixel in the target pixel and the specific sub-pixel in each of the pixel units around the target pixel unit comprises the second sub-pixel in the target pixel and the second sub-pixel in each of the pixel units around the target pixel unit and the third sub-pixel in the target pixel and the third sub-pixel in each of the pixel units around the target pixel unit; the sub-pixel rendering module recalculates brightness of the specific sub-pixel in the target pixel unit to output a second brightness of the specific sub-pixel in the target pixel unit; and
the first sub-pixel is a green sub-pixel, the second sub-pixel is one of a red sub-pixel and a blue sub-pixel, the third sub-pixel is the other of a red sub-pixel and a blue sub-pixel, the first sub-pixel in each of the pixel units shares a pixel definition opening with the first sub-pixel in an adjacent one of the pixel units, the second sub-pixel in each of the pixel units shares a pixel definition opening with the second sub-pixel in an adjacent one of the pixel units, and the third sub-pixel in each of the pixel units shares a pixel definition opening with the third sub-pixel in an adjacent one of the pixel units.

2. The display device according to claim 1, wherein the sub-pixel rendering module recalculates the brightness of the specific sub-pixel in the target pixel unit according to a rendering calculation matrix table, wherein the rendering calculation matrix table comprises a plurality of calculation blocks, the second brightness of the specific sub-pixel in the target pixel unit is equal to a sum of values of the plurality of calculation blocks, and a value of each of the calculation blocks is obtained by multiplying the first brightness of the specific sub-pixel of one of the target pixel unit and the pixel units around the target pixel unit by a compensation coefficient, and the value of each of at least two of the plurality of calculation blocks is greater than 0.

3. The display device according to claim 2, wherein the display panel has a display area, at least one of the pixel units is disposed between the target pixel unit and any edge of the display area, the pixel units around the target pixel unit comprise a second pixel unit, a third pixel unit, a fourth pixel unit, a fifth pixel unit, a sixth pixel unit, a seventh pixel unit, an eighth pixel unit, and a ninth pixel unit arranged in sequence in a clockwise direction, and the second pixel unit is disposed on one side of the target pixel unit facing toward the first direction; the plurality of calculation blocks comprise a target calculation block, and a second calculation block, a third calculation block, a fourth calculation block, a fifth calculation block, a sixth calculation block, a seventh calculation block, an eighth calculation block, and a ninth calculation block arranged in sequence in a clockwise direction around the target calculation block, the second calculation block is disposed on one side of the target calculation block facing toward the first direction;
wherein a first brightness of a specific sub-pixel in the target calculation block, a first brightness of a specific sub-pixel in the second calculation block, a first brightness of a specific sub-pixel in the third calculation block, a first brightness of a specific sub-pixel in the fourth calculation block, a first brightness of a specific sub-pixel in the fifth calculation block, a first brightness of a specific sub-pixel in the sixth calculation block, a first brightness of a specific sub-pixel in the seventh calculation block, a first brightness of a specific sub-pixel in the eighth calculation block, and a first brightness of a specific sub-pixel in the ninth calculation block correspond to the first brightness of the specific sub-pixel in the target pixel unit, the first brightness of the specific sub-pixel in the second pixel unit, the first brightness of the specific sub-pixel in the third pixel unit, the first brightness of the specific sub-pixel in the fourth pixel unit, the first brightness of the specific sub-pixel in the fifth pixel unit, the first brightness of the specific sub-pixel in the sixth pixel unit, the first brightness of the specific sub-pixel in the seventh pixel unit, the first brightness of the specific sub-pixel in the eighth pixel unit, and the first brightness of the specific sub-pixel in the ninth pixel unit, respectively;
when the specific sub-pixel is the second sub-pixel, the compensation coefficient of the second sub-pixel of the target calculation block is k1, the compensation coefficient of the second sub-pixel of the sixth calculation block is k2, k1 and k2 are both greater than 0, the sum of k1 and k2 is equal to 1, and the compensation coefficient of the second sub-pixel of each of the other calculation blocks is 0;
when the specific sub-pixel is the third sub-pixel, the compensation coefficient of the third sub-pixel of the target calculation block is k1, the compensation coefficient of the third sub-pixel of the second calculation block is k2, k1 and k2 are both greater than 0, the sum of k1 and k2 is equal to 1, and the compensation coefficient of the third sub-pixel of each of the other calculation blocks is 0.

4. The display device according to claim 3, wherein the specific sub-pixel does not comprise the first sub-pixel.

5. The display device according to claim 2, wherein the display panel has a display area, at least one of the pixel units is disposed between the target pixel unit and any edge of the display area, the pixel units around the target pixel unit comprise a second pixel unit, a third pixel unit, a fourth pixel unit, a fifth pixel unit, a sixth pixel unit, a seventh pixel unit, an eighth pixel unit, and a ninth pixel unit arranged in sequence in a clockwise direction, and the second pixel unit is disposed on one side of the target pixel unit facing toward the first direction; the plurality of calculation blocks comprise a target calculation block, and a second calculation block, a third calculation block, a fourth calculation block, a fifth calculation block, a sixth calculation block, a seventh calculation block, an eighth calculation block, and a ninth calculation block arranged in sequence in a clockwise direction around the target calculation block, the second calculation block is disposed on one side of the target calculation block facing toward the first direction; wherein
a first brightness of a specific sub-pixel in the target calculation block, a first brightness of a specific sub-pixel in the second calculation block, a first brightness of a specific sub-pixel in the third calculation block, a first brightness of a specific sub-pixel in the fourth calculation block, a first brightness of a specific sub-pixel in the fifth calculation block, a first brightness of a specific sub-pixel in the sixth calculation block, a first brightness of a specific sub-pixel in the seventh calculation block, a first brightness of a specific sub-pixel in the eighth calculation block, and a first brightness of a specific sub-pixel in the ninth calculation block correspond to the first brightness of the specific sub-pixel in the target pixel unit, the first brightness of the specific sub-pixel in the second pixel unit, the first brightness of the specific sub-pixel in the third pixel unit, the first brightness of the specific sub-pixel in the fourth pixel unit, the first brightness of the specific sub-pixel in the fifth pixel unit, the first brightness of the specific sub-pixel in the sixth pixel unit, the first brightness of the specific sub-pixel in the seventh pixel unit, the first brightness of the specific sub-pixel in the eighth pixel unit, and the first brightness of the specific sub-pixel in the ninth pixel unit, respectively;
when the second sub-pixel and the third sub-pixel in the target pixel unit are disposed on one side of the first sub-pixel facing toward the second direction, and
when the specific sub-pixel is the second sub-pixel, the compensation coefficient of the second sub-pixel of the target calculation block is m1, the compensation coefficient of the second sub-pixel of the seventh calculation block is m2, the compensation coefficient of the second sub-pixel of the sixth calculation block is m3, the compensation coefficient of the second sub-pixel of the fifth calculation block is m4, the compensation coefficient of the second sub-pixel of the fourth calculation block is m5, m1, m2, m3, m4 and m5 are all greater than 0, the sum of m1, m2, m3, m4 and m5 is equal to 1, and the compensation coefficient of the second sub-pixel of each of the other calculation blocks is 0;
when the specific sub-pixel is the third sub-pixel, the compensation coefficient of the third sub-pixel of the target calculation block is m1, the compensation coefficient of the third sub-pixel of the ninth calculation block is m2, the compensation coefficient of the third sub-pixel of the second calculation block is m3, the compensation coefficient of the third sub-pixel of the fourth calculation block is m4, the compensation coefficient of the third sub-pixel of the third calculation block is m5, m1, m2, m3, m4 and m5 are all greater than 0, the sum of m1, m2, m3, m4 and m5 is equal to 1, and the compensation coefficient of the third sub-pixel of each of the other calculation blocks is 0.

6. The display device according to claim 5, wherein
when the second sub-pixel and the third sub-pixel in the target pixel unit are disposed on the side of the first sub-pixel toward the second direction, the specific sub-pixel comprises the first sub-pixel, and
when the specific sub-pixel is the first sub-pixel, the compensation coefficient of the first sub-pixel of the target calculation block is n1, the compensation coefficient of the first sub-pixel of the eighth calculation block is n2, the compensation coefficient of the first sub-pixel of the fourth calculation block is n3, n1, n2 and n3 are all greater than 0, the sum of n1, n2 and n3 is equal to 1, and the compensation coefficient of the first sub-pixel of each of the other calculation blocks is 0.

7. The display device according to claim 6, wherein
when the second sub-pixel and the third sub-pixel in the target pixel unit are disposed on one side of the first sub-pixel facing opposite to the second direction, and
when the specific sub-pixel is the second sub-pixel, the compensation coefficient of the second sub-pixel of the target calculation block is m1, the compensation coefficient of the second sub-pixel of the fifth calculation block is m2, the compensation coefficient of the second sub-pixel of the sixth calculation block is m3, the compensation coefficient of the second sub-pixel of the seventh calculation block is m4, the compensation coefficient of the second sub-pixel of the eighth calculation block is m5, m1, m2, m3, m4 and m5 are all greater than 0, the sum of m1, m2, m3, m4 and m5 is equal to 1, and the compensation coefficient of the second sub-pixel of each of the other calculation blocks is 0;
when the specific sub-pixel is the third sub-pixel, the compensation coefficient of the third sub-pixel of the target calculation block is m1, the compensation coefficient of the third sub-pixel of the third calculation block is m2, the compensation coefficient of the third sub-pixel of the second calculation block is m3, the compensation coefficient of the third sub-pixel of the eighth calculation block is m4, the compensation coefficient of the third sub-pixel of the ninth calculation block is m5, m1, m2, m3, m4 and m5 are all greater than 0, the sum of m1, m2, m3, m4 and m5 is equal to 1, and the compensation coefficient of the third sub-pixel of each of the other calculation blocks is 0.

8. The display device according to claim 7, wherein
when the second sub-pixel and the third sub-pixel in the target pixel unit are disposed on the side of the first sub-pixel facing opposite to the second direction, the specific sub-pixel comprises the first sub-pixel, and
when the specific sub-pixel is the first sub-pixel, the compensation coefficient of the first sub-pixel of the target calculation block is n1, the compensation coefficient of the first sub-pixel of the fourth calculation block is n2, the compensation coefficient of the first sub-pixel of the eighth calculation block is n3, n1, n2, and n3 are all greater than 0, the sum of n1, n2, and n3 is equal to 1, and the compensation coefficient of the first sub-pixel of each of the other calculation blocks is 0.

9. The display device according to claim 2, wherein the display panel has a display area, and the target pixel unit is adjacent to an edge of the display area, wherein the first brightness of the specific sub-pixel in each of at least two calculation blocks of the plurality of calculation blocks corresponds to the first brightness of the specific sub-pixel in the same one of the pixel units.

10. A display device, wherein the display device comprises:
a display panel comprising a plurality of pixel units arranged in sequence in a first direction and a second direction, the first direction intersecting the second direction, each of the pixel units comprising three sub-pixels of different colors, the three sub-pixels being a first sub-pixel, a second sub-pixel and a third sub-pixel, respectively, wherein the first sub-pixel in one of the pixel units is disposed on one side of the second sub-pixel and the third sub-pixel facing toward the second direction, the first sub-pixel in an adjacent one of the pixel units is disposed on one side of the second sub-pixel and the third sub-pixel facing opposite to the second direction, one side of each first sub-pixel facing toward the first direction is adjacent to the second sub-pixel in one of the pixel units, and one side of each first sub-pixel facing opposite to the first direction is adjacent to the third sub-pixel in one of the pixel units;
a driving chip electrically connected to the display panel, the driving chip comprising a first brightness module and a sub-pixel rendering module, wherein the first brightness module outputs a first brightness of a specific one of the sub-pixels in a target pixel unit of the pixel units and a first brightness of a specific one of the sub-pixels in each of the pixel units around the target pixel unit to the sub-pixel rendering module, the specific sub-pixel in the target pixel and the specific sub-pixel in each of the pixel units around the target pixel unit comprises the second sub-pixel in the target pixel and the second sub-pixel in each of the pixel units around the target pixel unit and the third sub-pixel in the target pixel and the third sub-pixel in each of the pixel units around the target pixel unit; the sub-pixel rendering module recalculates brightness of the specific sub-pixel in the target pixel unit to output a second brightness of the specific sub-pixel in the target pixel unit.

11. The display device according to claim 10, wherein the sub-pixel rendering module recalculates the brightness of the specific sub-pixel in the target pixel unit according to a rendering calculation matrix table, wherein the rendering calculation matrix table comprises a plurality of calculation blocks, the second brightness of the specific sub-pixel in the target pixel unit is equal to a sum of values of the plurality of calculation blocks, and a value of each of the calculation blocks is obtained by multiplying the first brightness of the specific sub-pixel of one of the target pixel unit and the pixel units around the target pixel unit by a compensation coefficient, and the value of each of at least two of the plurality of calculation blocks is greater than 0.

12. The display device according to claim 10, wherein the first sub-pixel is a green sub-pixel, the second sub-pixel is one of a red sub-pixel and a blue sub-pixel, the third sub-pixel is the other of a red sub-pixel and a blue sub-pixel, the first sub-pixel in each of the pixel units shares a pixel definition opening with the first sub-pixel in an adjacent one of the pixel units, the second sub-pixel in each of the pixel units shares a pixel definition opening with the second sub-pixel in an adjacent one of the pixel units, and the third sub-pixel in each of the pixel units shares a pixel definition opening with the third sub-pixel in an adjacent one of the pixel units.

13. The display device according to claim 11, wherein the display panel has a display area, at least one of the pixel units is disposed between the target pixel unit and any edge of the display area, the pixel units around the target pixel unit comprise a second pixel unit, a third pixel unit, a fourth pixel unit, a fifth pixel unit, a sixth pixel unit, a seventh pixel unit, an eighth pixel unit, and a ninth pixel unit arranged in sequence in a clockwise direction, and the second pixel unit is disposed on one side of the target pixel unit facing toward the first direction; the plurality of calculation blocks comprise a target calculation block, and a second calculation block, a third calculation block, a fourth calculation block, a fifth calculation block, a sixth calculation block, a seventh calculation block, an eighth calculation block, and a ninth calculation block arranged in sequence in a clockwise direction around the target calculation block, the second calculation block is disposed on one side of the target calculation block facing toward the first direction;
wherein a first brightness of a specific sub-pixel in the target calculation block, a first brightness of a specific sub-pixel in the second calculation block, a first brightness of a specific sub-pixel in the third calculation block, a first brightness of a specific sub-pixel in the fourth calculation block, a first brightness of a specific sub-pixel in the fifth calculation block, a first brightness of a specific sub-pixel in the sixth calculation block, a first brightness of a specific sub-pixel in the seventh calculation block, a first brightness of a specific sub-pixel in the eighth calculation block, and a first brightness of a specific sub-pixel in the ninth calculation block correspond to the first brightness of the specific sub-pixel in the target pixel unit, the first brightness of the specific sub-pixel in the second pixel unit, the first brightness of the specific sub-pixel in the third pixel unit, the first brightness of the specific sub-pixel in the fourth pixel unit, the first brightness of the specific sub-pixel in the fifth pixel unit, the first brightness of the specific sub-pixel in the sixth pixel unit, the first brightness of the specific sub-pixel in the seventh pixel unit, the first brightness of the specific sub-pixel in the eighth pixel unit, and the first brightness of the specific sub-pixel in the ninth pixel unit, respectively;
when the specific sub-pixel is the second sub-pixel, the compensation coefficient of the second sub-pixel of the target calculation block is k1, the compensation coefficient of the second sub-pixel of the sixth calculation block is k2, k1 and k2 are both greater than 0, the sum of k1 and k2 is equal to 1, and the compensation coefficient of the second sub-pixel of each of the other calculation blocks is 0;
when the specific sub-pixel is the third sub-pixel, the compensation coefficient of the third sub-pixel of the target calculation block is k1, the compensation coefficient of the third sub-pixel of the second calculation block is k2, k1 and k2 are both greater than 0, the sum of k1 and k2 is equal to 1, and the compensation coefficient of the third sub-pixel of each of the other calculation blocks is 0.

14. The display device according to claim 13, wherein the specific sub-pixel does not comprise the first sub-pixel.

15. The display device according to claim 11, wherein the display panel has a display area, at least one of the pixel units is disposed between the target pixel unit and any edge of the display area, the pixel units around the target pixel unit comprise a second pixel unit, a third pixel unit, a fourth pixel unit, a fifth pixel unit, a sixth pixel unit, a seventh pixel unit, an eighth pixel unit, and a ninth pixel unit arranged in sequence in a clockwise direction, and the second pixel unit is disposed on one side of the target pixel unit facing toward the first direction; the plurality of calculation blocks comprise a target calculation block, and a second calculation block, a third calculation block, a fourth calculation block, a fifth calculation block, a sixth calculation block, a seventh calculation block, an eighth calculation block, and a ninth calculation block arranged in sequence in a clockwise direction around the target calculation block, the second calculation block is disposed on one side of the target calculation block facing toward the first direction; wherein
a first brightness of a specific sub-pixel in the target calculation block, a first brightness of a specific sub-pixel in the second calculation block, a first brightness of a specific sub-pixel in the third calculation block, a first brightness of a specific sub-pixel in the fourth calculation block, a first brightness of a specific sub-pixel in the fifth calculation block, a first brightness of a specific sub-pixel in the sixth calculation block, a first brightness of a specific sub-pixel in the seventh calculation block, a first brightness of a specific sub-pixel in the eighth calculation block, and a first brightness of a specific sub-pixel in the ninth calculation block correspond to the first brightness of the specific sub-pixel in the target pixel unit, the first brightness of the specific sub-pixel in the second pixel unit, the first brightness of the specific sub-pixel in the third pixel unit, the first brightness of the specific sub-pixel in the fourth pixel unit, the first brightness of the specific sub-pixel in the fifth pixel unit, the first brightness of the specific sub-pixel in the sixth pixel unit, the first brightness of the specific sub-pixel in the seventh pixel unit, the first brightness of the specific sub-pixel in the eighth pixel unit, and the first brightness of the specific sub-pixel in the ninth pixel unit, respectively;
when the second sub-pixel and the third sub-pixel in the target pixel unit are disposed on one side of the first sub-pixel facing toward the second direction, and
when the specific sub-pixel is the second sub-pixel, the compensation coefficient of the second sub-pixel of the target calculation block is m1, the compensation coefficient of the second sub-pixel of the seventh calculation block is m2, the compensation coefficient of the second sub-pixel of the sixth calculation block is m3, the compensation coefficient of the second sub-pixel of the fifth calculation block is m4, the compensation coefficient of the second sub-pixel of the fourth calculation block is m5, m1, m2, m3, m4 and m5 are all greater than 0, the sum of m1, m2, m3, m4 and m5 is equal to 1, and the compensation coefficient of the second sub-pixel of each of the other calculation blocks is 0;
when the specific sub-pixel is the third sub-pixel, the compensation coefficient of the third sub-pixel of the target calculation block is m1, the compensation coefficient of the third sub-pixel of the ninth calculation block is m2, the compensation coefficient of the third sub-pixel of the second calculation block is m3, the compensation coefficient of the third sub-pixel of the fourth calculation block is m4, the compensation coefficient of the third sub-pixel of the third calculation block is m5, m1, m2, m3, m4 and m5 are all greater than 0, the sum of m1, m2, m3, m4 and m5 is equal to 1, and the compensation coefficient of the third sub-pixel of each of the other calculation blocks is 0.

16. The display device according to claim 15, wherein
when the second sub-pixel and the third sub-pixel in the target pixel unit are disposed on the side of the first sub-pixel toward the second direction, the specific sub-pixel comprises the first sub-pixel, and
when the specific sub-pixel is the first sub-pixel, the compensation coefficient of the first sub-pixel of the target calculation block is n1, the compensation coefficient of the first sub-pixel of the eighth calculation block is n2, the compensation coefficient of the first sub-pixel of the fourth calculation block is n3, n1, n2 and n3 are all greater than 0, the sum of n1, n2 and n3 is equal to 1, and the compensation coefficient of the first sub-pixel of each of the other calculation blocks is 0.

17. The display device according to claim 16, wherein
when the second sub-pixel and the third sub-pixel in the target pixel unit are disposed on one side of the first sub-pixel facing opposite to the second direction, and
when the specific sub-pixel is the second sub-pixel, the compensation coefficient of the second sub-pixel of the target calculation block is m1, the compensation coefficient of the second sub-pixel of the fifth calculation block is m2, the compensation coefficient of the second sub-pixel of the sixth calculation block is m3, the compensation coefficient of the second sub-pixel of the seventh calculation block is m4, the compensation coefficient of the second sub-pixel of the eighth calculation block is m5, m1, m2, m3, m4 and m5 are all greater than 0, the sum of m1, m2, m3, m4 and m5 is equal to 1, and the compensation coefficient of the second sub-pixel of each of the other calculation blocks is 0;
when the specific sub-pixel is the third sub-pixel, the compensation coefficient of the third sub-pixel of the target calculation block is m1, the compensation coefficient of the third sub-pixel of the third calculation block is m2, the compensation coefficient of the third sub-pixel of the second calculation block is m3, the compensation coefficient of the third sub-pixel of the eighth calculation block is m4, the compensation coefficient of the third sub-pixel of the ninth calculation block is m5, m1, m2, m3, m4 and m5 are all greater than 0, the sum of m1, m2, m3, m4 and m5 is equal to 1, and the compensation coefficient of the third sub-pixel of each of the other calculation blocks is 0.

18. The display device according to claim 17, wherein
when the second sub-pixel and the third sub-pixel in the target pixel unit are disposed on the side of the first sub-pixel facing opposite to the second direction, the specific sub-pixel comprises the first sub-pixel, and
when the specific sub-pixel is the first sub-pixel, the compensation coefficient of the first sub-pixel of the target calculation block is n1, the compensation coefficient of the first sub-pixel of the fourth calculation block is n2, the compensation coefficient of the first sub-pixel of the eighth calculation block is n3, n1, n2, and n3 are all greater than 0, the sum of n1, n2, and n3 is equal to 1, and the compensation coefficient of the first sub-pixel of each of the other calculation blocks is 0.

19. The display device according to claim 11, wherein the display panel has a display area, and the target pixel unit is adjacent to an edge of the display area, wherein the first brightness of the specific sub-pixel in each of at least two calculation blocks of the plurality of calculation blocks corresponds to the first brightness of the specific sub-pixel in the same one of the pixel units.

20. A sub-pixel rendering method for driving a plurality of pixel units of a display panel, wherein the display panel comprises a plurality of pixel units arranged in sequence in a first direction and a second direction, the first direction intersects the second direction, each of the pixel units comprises three sub-pixels of different colors, the three sub-pixels are a first sub-pixel, a second sub-pixel and a third sub-pixel, respectively, wherein the first sub-pixel in one of the pixel units is disposed on one side of the second sub-pixel and the third sub-pixel facing toward the second direction, the first sub-pixel in an adjacent one of the pixel units is disposed on one side of the second sub-pixel and the third sub-pixel facing opposite to the second direction, one side of each first sub-pixel facing toward the first direction is adjacent to the second sub-pixel in one of the pixel units, and one side of each first sub-pixel facing opposite to the first direction is adjacent to the third sub-pixel in one of the pixel units;
the sub-pixel rendering method comprises steps of:
obtaining position information of a target pixel unit of the pixel units and a first brightness of a specific sub-pixel in the target pixel unit, and a first brightness of a specific sub-pixel in each of the pixel units around the target pixel unit, the specific sub-pixel comprising the second sub-pixel and the third sub-pixel; and
recalculating brightness of the specific sub-pixel in the target pixel unit according to a rendering calculation matrix table to output a second brightness of the specific sub-pixel in the target pixel unit;
wherein the rendering calculation matrix table comprises a plurality of calculation blocks, the second brightness of the specific sub-pixel in the target pixel unit is equal to a sum of values of the plurality of calculation blocks, and a value of each of the calculation blocks is obtained by multiplying the first brightness of the specific sub-pixel of one of the target pixel unit and the pixel units around the target pixel unit by a compensation coefficient, and a value of each of at least two of the plurality of calculation blocks is greater than 0.
